(19) United States
(12) Patent Application Publication
(10) Pub. No.: US 2017/0074307 A1
(43) Pub. Date: Mar. 16, 2017

(54) METHODS, SYSTEMS AND COMPONENTS FOR DESIGNING AND/OR ASSEMBLING A SHELVING UNIT

(71) Applicant: Anthony R. SLAGLE, Charlotte, NC (US)

(72) Inventor: Anthony R. SLAGLE, Charlotte, NC (US)

(21) Appl. No.: 15/251,380

(22) Filed: Aug. 30, 2016

Related U.S. Application Data
(60) Provisional application No. 62/217,188, filed on Sep. 11, 2015.

(51) Int. Cl. F16B 12/20; A47B 47/00

(52) U.S. Cl. CPC F16B 12/20; A47B 47/0091; A47B 47/0075; A47B 2230/16

(57) ABSTRACT

In one aspect, a method of hanging a fixture from a substantially vertical surface is described herein. In some embodiments, the method comprises providing a spring cleat. The spring cleat comprises a housing, a lever arm, and a hook. The housing has a first surface and a second surface. The lever arm is pivotally connected to the housing and is spring biased toward the first surface of the housing in an extended position. The hook is attached to the lever arm. The lever arm, upon application of a force opposite the first surface upon at least one of the lever arm and the hook, is operable to pivot away from the first surface of the housing towards a depressed position. The method further comprises providing a French cleat operable to engage the hook of the spring cleat.

### CROSS REFERENCE TO RELATED APPLICATIONS

This application claims priority pursuant to 35 U.S.C. §119(e) to U.S. Provisional Patent Application Ser. No. 62/217,188, filed on Sep. 11, 2015, which is hereby incorporated by reference in its entirety.

### FIELD

The present disclosure relates to methods, systems, and individual components usable in designing and/or assembling a modular shelving and/or storage unit.

### BACKGROUND

Shelving units are often provided by a manufacturer in a predetermined arrangement or adapted to be assembled in such an arrangement. Such shelving units are generally either cumbersome or require either a large time investment or require a professional craftsman in order to be assembled. Custom shelving and/or storage units have been attempted, but such solutions generally require an average consumer to hire a professional to design and implement the custom solution. Additionally, such solutions offer very little after-market or after-purchase customization as the needs of the consumer change. Moreover, third-party additions to such custom solutions are generally difficult or impossible to implement. Therefore, improved methods, systems and components for designing and/or assembling a shelving or storage unit are required. Such a system described herein may demonstrate one or more of consumer-customizable design, ease of transport, and/or ease of assembly. Additionally, such a system, method or component may permit or facilitate modification of the shelving or storage unit by a third party in an after-market or after-purchase setting.

### SUMMARY

In one aspect, methods for facilitating computer-implemented design of shelving components are described herein. Methods described herein can provide one or more advantages compared to other methods. For example, in some embodiments, methods described herein can permit a user to design, place, manipulate and validate a shelving arrangement virtually prior to purchase of any components.

In some embodiments, a method described herein comprises providing a graphical user interface. The graphical user interface can be provided on a computing system based on computer readable program code portions stored on a computer-readable storage medium. The graphical user interface enables a user to: a) graphically define a wall space on which the shelving components will be designed; b) select shelving components from a predetermined set of shelving components; c) place and manipulate selected shelving components into a custom design on a visible snap grid that aligns with the graphically defined wall space; and d) three dimensionally view the custom design on the graphically defined wall space. A method described herein can further comprise validating with at least one central processing unit (CPU) in the computing system the user's custom design of the shelving components by comparing the custom design to validation data. The validation data is selected from the group consisting of shelving load capacity data, shelving balance data, dimensions of the wall space, shelving support bracket data, electrical wire placement data, and electrical circuit load data. The method can further comprise enabling the user to further manipulate, add, or remove shelving components via the graphical user interface based on results of the validating step. Additionally, methods described herein can further comprise calculating with the at least one CPU the dimensions of the user's custom design of the shelving components. Further, in some cases, the method can comprise enabling the user to confirm acceptance of the user's custom design via the graphical user interface.

Systems for facilitating computer-implemented design of shelving components are also described herein. In some embodiments, systems described herein comprise at least one computer comprising at least one central processing unit (CPU) and at least one memory having computer-readable program code portions stored therein that, when executed by the at least one processing unit, cause the computer to at least: a) provide a graphical user interface; b) validate the user's custom design of the shelving components; c) enable the user to further manipulate, add, or remove shelving components via the graphical user interface based on the results of the validation; d) calculate the dimensions of the user's custom design of the shelving components; and e) enable the user to confirm acceptance of the user's custom design via the graphical user interface. The graphical user interface enables a user to: 1) graphically define a wall space on which the shelving components will be designed; 2) select shelving components from a predetermined set of shelving components; 3) place and manipulate selected shelving components into a custom design on a visible snap grid that is aligned with the graphically defined wall space; and 4) three dimensionally view the custom design on the graphically defined wall space. Validating the user's custom design is performed by comparing the custom design to validation data, the validation data being selected from the group consisting of shelving load capacity data, shelving balance data, dimensions of the wall space, shelving support bracket data, electrical wire placement data, and electrical circuit load data.

A computer readable storage medium for managing assembly of a multi-part product in a production environment is also described herein. The computer readable storage medium is non-transitory and has computer readable program code portions stored therein that, in response to execution by one or more central processing units (CPUs) and/or more additional CPUs, cause a computer system to perform certain tasks. For example, the computer readable program code portions can cause a computer system to at least: a) provide a graphical user interface; b) validate the user's custom design of the shelving components; c) enable the user to further manipulate, add, or remove shelving components via the graphical user interface based on the results of the validation; d) calculate the dimensions of the user's custom design of the shelving components; and e) enable the user to confirm acceptance of the user's custom design via the graphical user interface. The graphical user interface enables a user to: 1) graphically define a wall space on which the shelving components will be designed; 2) select shelving components from a predetermined set of shelving components; 3) place and manipulate selected shelving components into a custom design on a visible snap grid that is aligned with the graphically defined wall space; and 4) three dimensionally view the custom design on the graphically defined wall space. Validating the user's custom design is performed by comparing the custom design to validation data, the validation data being selected from the group consisting of shelving load capacity data, shelving balance data, dimensions of the wall space, shelving support bracket data, electrical wire placement data, and electrical circuit load data.

In another aspect, a spring cleat is described herein. A spring cleat can provide one or more advantages compared to other wall-hanging structures. For instance, a spring cleat described herein can provide a tactile and/or audio cue when proper vertical positioning of a fixture relative to a substantially vertical surface is achieved. Additionally, in some embodiments, a spring cleat described herein can be recessed or partially recessed within one of a substantially vertical surface and/or a fixture to be mounted to the substantially vertical surface.

In some embodiments, a spring cleat comprises a housing having a first surface, a lever arm movably connected to the housing and spring biased toward the first surface of the housing in an extended position, and a hook attached to the lever arm. In such embodiments, the lever arm can be operable, upon application of a force in a first direction and opposite the first surface upon at least one of the lever arm and the hook, to move away from the first surface of the housing towards a depressed position. For example, in some embodiments, a spring cleat comprises a housing, a lever arm, and a hook. The housing has a first surface and a second surface. The lever arm is pivotally connected to the housing and is spring biased toward the first surface of the housing in an extended positon. The hook is attached to the lever arm. The lever arm, upon application of a force opposite the first surface upon at least one of the lever arm and the hook, is operable to pivot away from the first surface of the housing towards a depressed position. In certain other embodiments, a spring cleat comprises a housing, a lever arm, and a hook. The housing comprises a first surface. The lever arm is slidably attached to the housing by a spring-rod and is spring biased toward the first surface of the housing in an extended position. The hook is attached to the lever arm. The lever arm, upon application of a force in a first direction opposite the first surface upon at least one of the lever arm and the hook, is operable to slide away from the first surface of the housing towards a depressed position of the housing.

In a further aspect, a system of hanging a fixture from a substantially vertical surface is described herein. In some embodiments, the system can comprise a spring cleat which comprises a housing, a lever arm, and a hook. The housing has a first surface and a second surface. The lever arm is pivotally connected to the housing and is spring biased toward the first surface of the housing in an extended position. The hook is attached to the lever arm. The lever arm, upon application of a force opposite the first surface upon at least one of the lever arm and the hook, is operable to pivot away from the first surface of the housing toward a depressed position of the lever arm.

In a yet further aspect, a method of hanging a fixture from a substantially vertical surface is described herein. In some embodiments, a method described herein comprises providing a spring cleat. A spring cleat can comprise a housing, a lever arm, and a hook. The housing has a first surface and a second surface. The lever arm is pivotally connected to the housing and is spring biased toward the first surface of the housing in an extended position. The hook is attached to the lever arm. The lever min, upon application of a force opposite the first surface upon at least one of the lever arm and the hook, is operable to pivot away from the first surface of the housing towards a depressed position. The method further comprises providing a French cleat operable to engage the hook of the spring cleat. The French cleat has a substantially vertical portion and a hook-engaging portion oblique to the substantially vertical portion. The hook-engaging portion has a first side and a second side, the first side being adapted to face the substantially vertical surface when the French cleat is fastened to the substantially vertical surface and to face the fixture when the French cleat is fastened to the fixture. The second side faces in an opposite direction of the first side. The method can further comprise positioning the hook of the spring cleat proximate to the second side of the French cleat and moving the spring cleat and the French cleat relative to one another. Moving the spring cleat and the French cleat relative to one another can: first cause the second surface of the French cleat to apply force to the lever arm to cause the lever arm to pivot towards the depressed position; then cause the lever arm to pivot towards the extended position; and then engage the first surface of the French cleat with the hook of the spring cleat.

In an additional aspect, a system for electrically wiring a joined panel assembly is described herein. In some embodiments, a system described herein can provide certain advantages over other systems of electrically wiring a joined panel assembly. For example, a system described herein can provide electrically wired panels having flat or flush mounting surfaces.

In some embodiments, a system for electrically wiring a joined panel assembly described herein can comprise a first panel, a second panel, a first power connector, and a second power connector. The first power connector is attached to the first panel and is flush with at least one surface of the first panel. The second power connector is attached to the second panel and is flush with at least one surface of the second panel. The second power connector is adapted to electrically connect to the first power connector. Further, the first panel and the second panel are adapted to abut and form a joint, the joint defining an angle θ greater than 0° and less than 180°.

In a further aspect, methods of making an electrically wired assembly are described herein. In some embodiments, a method described herein comprises providing a first panel and a second panel. The method further comprises attaching a first power connector to the first panel flush with at least one surface of the first panel and attaching a second power connector to the second panel flush with at least one surface of the second panel. The method can further comprise abutting the first panel to the second panel to define an angle θ greater than 0° and less than 180°. The method further comprises electrically connecting the first power connector to the second power connector.

These and other implementations are described in more detail in the detailed description which follows.

### BRIEF DESCRIPTION OF THE FIGURES

FIG. 1 illustrates a process flow chart consistent with methods for facilitating computer-implemented design of shelving components according to one embodiment described herein.

FIG. 2 illustrates a perspective view of a panel usable in one or more embodiments of methods and systems described herein.

FIG. 3 illustrates a partially transparent perspective view of a panel usable in methods and systems consistent with one or more embodiments described herein.

FIGS. 4A and 4B illustrate perspective views consistent with one embodiment of a spring cleat described herein.

FIG. 5A-5D illustrate partially transparent perspective views of the spring cleat of FIGS. 4A and 4B.

FIG. 6 illustrates a perspective view of a spring cleat mounted within a recess defined by a substantially vertical surface or a fixture consistent with one embodiment described herein.

FIG. 7 illustrates a partially transparent perspective view of a spring cleat mounted within a recess defined by a substantially vertical surface or a fixture consistent with one embodiment described herein.

FIGS. 8A-8D illustrate perspective views of one embodiment of a spring cleat described herein which is attached to a substantially vertical surface or to a fixture.

FIGS. 9A and 9B illustrate partially transparent perspective views of the spring cleat of FIGS. 8A-8D.

FIGS. 10A-10E illustrate a system for hanging a fixture from a substantially vertical surface consistent with one embodiment described herein.

FIGS. 11A-11F illustrate one embodiment of a method of hanging a fixture from a substantially vertical surface described herein.

FIGS. 12A and 12B illustrate perspective views of a power connector usable in one embodiment of a system for electrically wiring a joined panel assembly described herein.

FIGS. 13A-13D illustrate partially transparent perspective views of the power connector of FIGS. 12A and 12B.

FIGS. 14A-14D illustrate partially transparent perspective views of a power connector usable in one embodiment of a system for electrically wiring a joined panel assembly described herein

FIGS. 15A-15D illustrate perspective views of the power connector of FIGS. 14A-14D.

FIG. 16A-16G illustrate perspective views of one embodiment of a system for electrically wiring a joined panel assembly described herein.

FIGS. 17A-17H illustrate one embodiment of a method of making an electrically wired assembly described herein.

FIGS. 18A-18E illustrate perspective views of a panel usable in one embodiment of a system for electrically wiring a joined panel assembly described herein.

FIG. 19 illustrates a partially transparent perspective view of a spring cleat according to one embodiment described herein.

### DETAILED DESCRIPTION

Implementations described herein can be understood more readily by reference to the following detailed description, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” should generally be considered to include the end points of 5 and 10.

### I. Methods, Systems and Computer Readable Storage Media for Assembling Shelving

In one aspect, a shelf creation system and processes associated with such a system are described herein. Naui Shelf is a collection of building components consisting of joinable edges or panels forming a framework for integratable elements and an optional network of wires to supply power. An assembled Naui Shelf system can be either free-standing or affixed to a wall using brackets. The set of integratable elements are divided into classes and described by standards such that third party vendors are encouraged to create compatible elements.

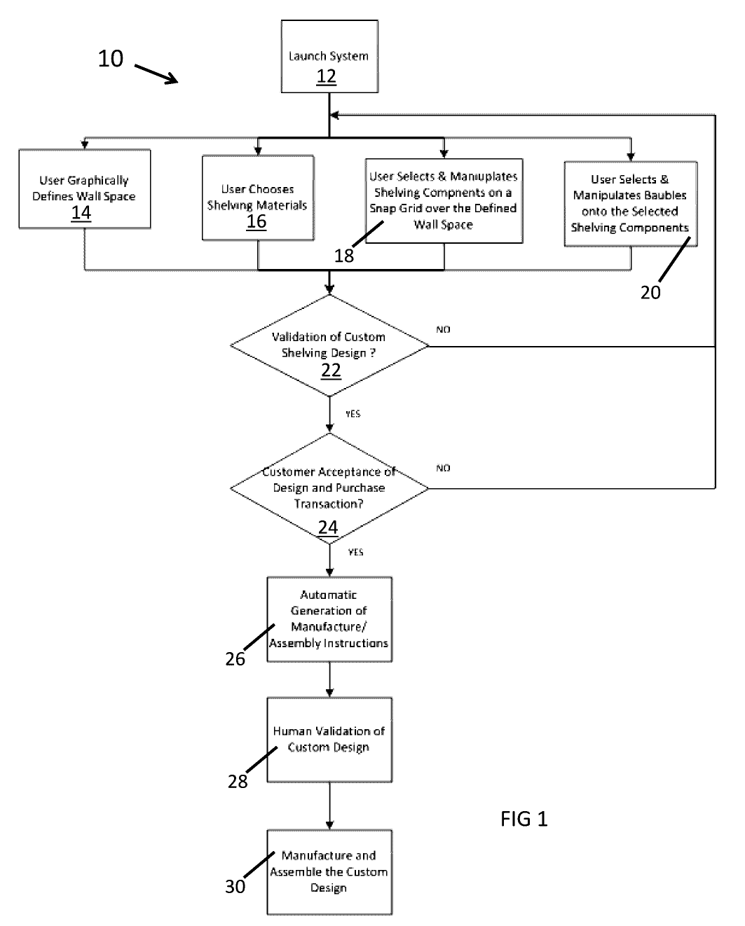

The Naui Shelf creation system, as shown in FIG. 1, consists of the collection of building components including the joinable shelving components, a set integratable elements conforming to rules describing methods of integration to the Naui Shelf framework, a software application for laying out components and elements and validating the design, a digital representation format easing automated manufacturing, and a formula which generates parts list and assembly instructions given input of the digital representation.

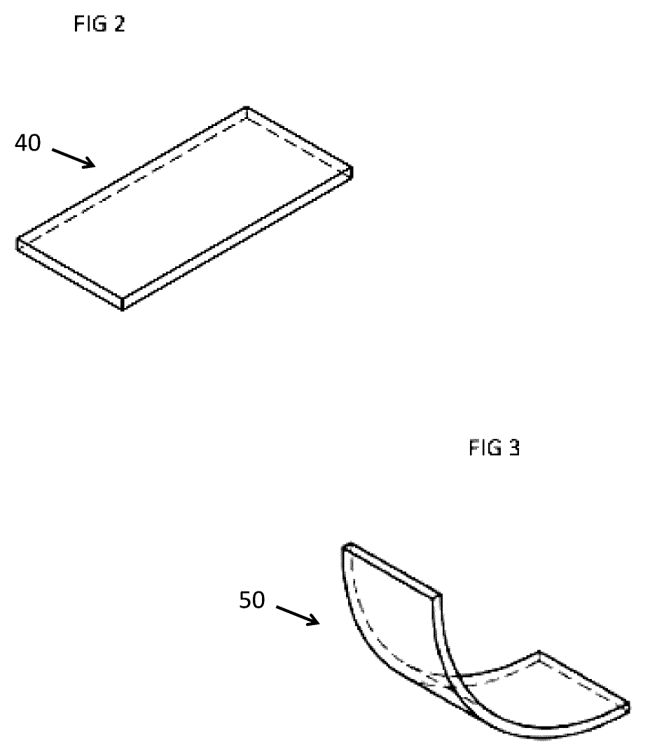

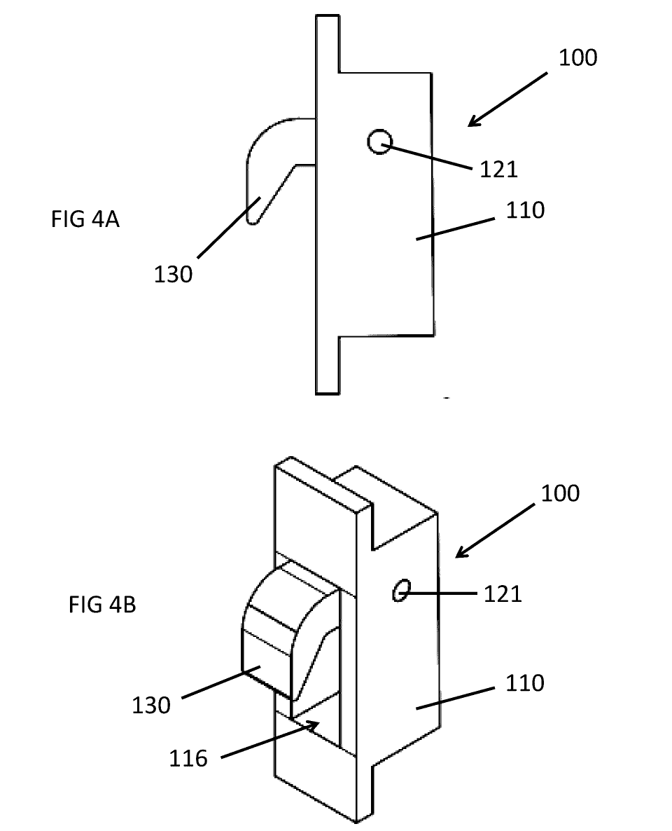

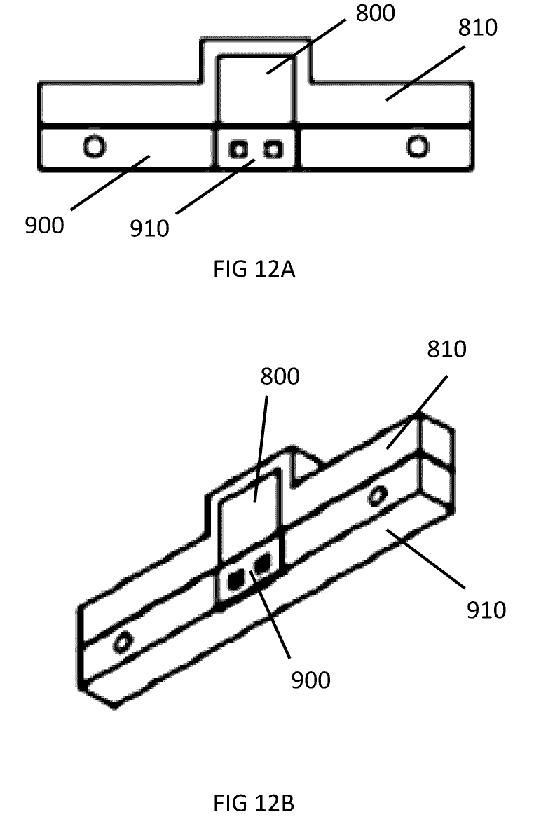

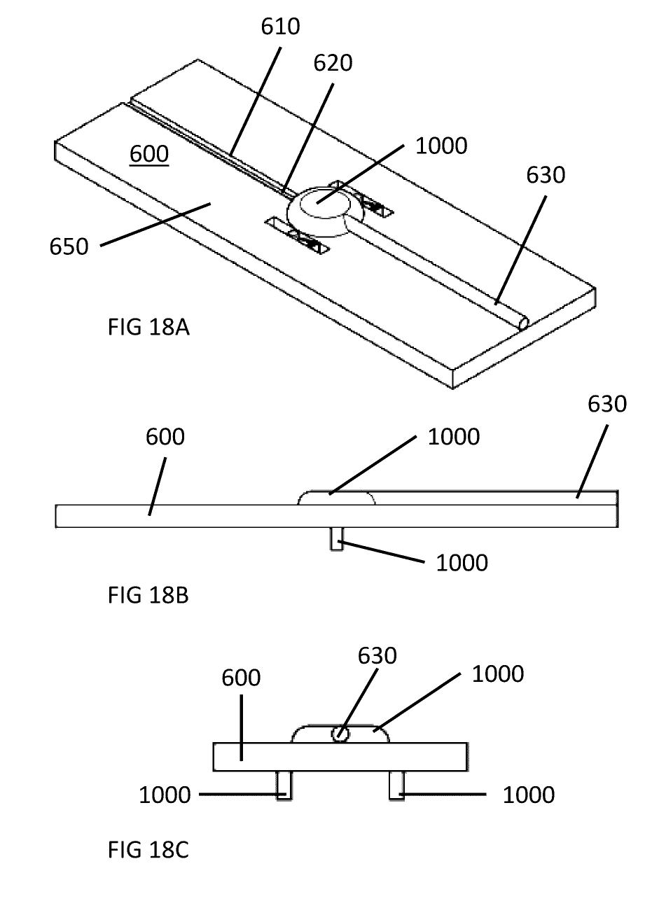

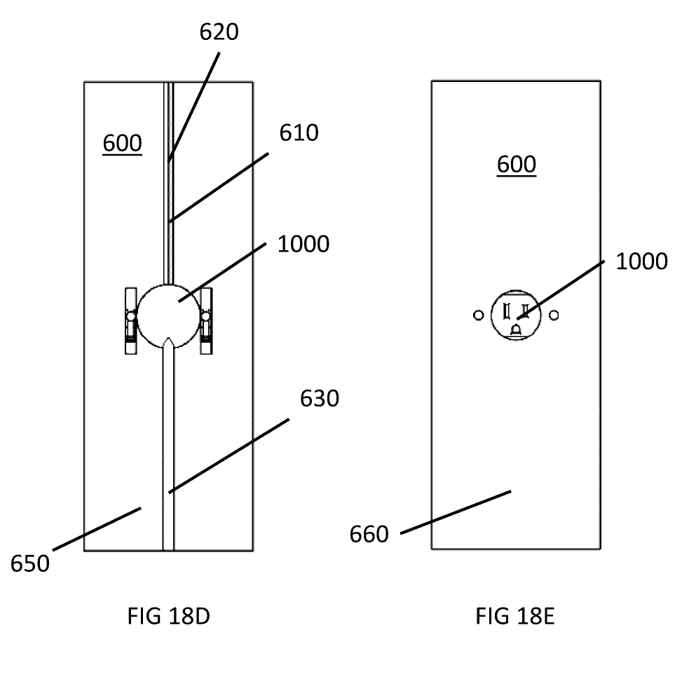

The collection of building components referenced above includes the following components:
Edges or Panels—The main structural component of the Naui Shelf system. Straight or continuously curved planks of various materials (e.g. wood), as shown in FIGS. 2 and 3 respectively, with ends possibly having mate-able joints if to be joined to other edges. An example straight edge on a 12″ grid could be a cedar plank with dimensions ½″×5½″×12″. A similar curved edge on a 12″ grid could have a radius of 12″.
Brackets—One example of a structure which may be used to attach Naui Shelves to walls includes the Naui Designs “Spring Cleat,” as described in detail below with respect to FIGS. 4A-11F. The spring cleat is in-set in the back of vertical edge pieces and hooks into a wall mounted modified French cleat. The floating shelf bracket is one of many structures or configurations which can be used to support horizontal edges. Other brackets, nails, screws, or other attachment means may also be used.
Joints—Various joint styles and decorative connectors facilitate joining edges at their ends to simplify customer assembly and/or to improve the fit of joined components. Example joint styles are cross-dowels, non-electrical Naui Joints, and electrical Naui Joints (as described further herein below).
Electricity—Optionally, power is supplied to elements via a mathematically optimized network of wires routed along the edges to Naui Ports, as shown in FIGS. 12A-17H. In the case of non-point-elements, such as led strip lighting, inductive power pads, etc., such non-point-elements are wired directly.
Other Elements—Standards documents will describe integration of both point elements and integratable non-point elements, and compliance assistance will be provided to 3^{rd} party designers who wish to create elements compatible with Naui Designs. Examples of elements include: light sockets, inductive pads (to power cell phones, votive candles, etc.), motion sensors, specialty lighting including LED strip lighting, Bluetooth controlled lighting, power switches (in line on/off switch, foot on/off switch, mounted on/off/dimmer switches), doors, glass/plexi-glass, mirrored tiles, light deflectors/shades, and shelf vases. Powered elements will attach securely to the Naui Port, as shown in FIGS. 18A-18E.

Referring again to FIG. 1, an overview of the Naui Shelf creation process 10 workflow is as follows:
1. Customer launches Naui Shelf designer (web/phone/computer app or in-store kiosk).—Step 12.
2. Customer modifies design until he or she is satisfied with the look.
   2.1. Customize Wall-Space—Step 14
   2.2. Customize Edges—Steps 16 and 18
   2.3. Customize Non-Edge Elements—Step 20
3. Customer initiates validation and load-balancing. —Step 22
4. Customer accepts design and completes purchase. —Step 24
5. Server processes order and auto-generates documentation. —Step 26
   5.1. Custom Assembly Instructions
   5.2. Bill of Materials
   5.3. Stickers for each part
   5.4. QR Code link
6. Human at Naui Designs verifies design and documentation—Step 28
7. Naui Designs fills the order. —Step 30
   7.1. Cut and label parts
   7.2. Package and Ship

Again referring to FIG. 1, a more detailed explanation of the Naui Shelf creation process 10 is as follows:
1. Customer launches Naui Shelf designer (web/phone/computer app or in-store kiosk).—Step 12
   1.1. Visit nauishelf.com and launch designer
   1.2. Open generated link to a design (bookmark, shared via social media*, etc.)
   1.3. Scan QR code on an existing shelf
2. Customer modifies design until he or she is satisfied with the look. Shelf elements are 3D rendered over background to create a feeling of realism and immersion.
   2.1. Customize wall-space. —Step 14
      2.1.1. Choose from stock wall images
      2.1.2. Upload image of wall area
         2.1.2.1. Pick at least two points of reference with known separation
         2.1.2.2. Choose at least one level line (floor or ceiling corner/furniture/chair rail/etc.)
         2.1.2.3. Auto-detect ambient light or adjust manually
         2.1.2.3.1. To auto detect white balance/brightness/hue, upload a picture of plain white paper taped on the wall and covering one third the width/height of the image.
         2.1.2.3.2. If manual, an object (e.g. beach ball, cat) will be rendered on a shelf in the picture so light properties (incident angle, hue, brightness, softness) can be adjusted to match scene.
   2.2. Adjust “camera height” (angle for rendering)
   2.3. Grid scaling and alignment: scaling grid will scale edges accordingly but not point objects (i.e. light bulbs and most 3^{rd} party elements will remain standard size)
   2.4. A future revision to the online Naui Shelf designer will allow for designs that span convex and concave architectural corners
   2.5. Customize and place edges. —Step 22
      2.5.1. Modify shelf depth (and consequently the width of edges).
      2.5.2. Choose edge materials.
         2.5.2.1. Common, exotic, and reclaimed woods such as cedar, oak, walnut, teakwood, etc.
         2.5.2.2. Engineered woods such as plywood, MDF and waffle-board
         2.5.2.3. Other materials such as recycled plastics, metals and combinations of materials.
   2.6. Place edges on layout grid.
      2.6.1. Through the process of customizing wall space, a layout grid is established to which edges can snap.
      2.6.2. Unit edge is a span of edge material between two grid corners.
         2.6.2.1. Straight unit edges can align vertically, horizontally, or diagonally as long as they connect two grid corners. (Max unit edge length will be limited)
         2.6.2.2. Curved unit edges' ends will have the same requirements as straight edges but will be curved.
   2.7. Customize non-edge elements.
      2.7.1. Baubles are items affixed to shelving edges
         2.7.1.1. Point objects are centered or distributed on unit edges. (Limitations may apply.) Examples include but are not limited to:
         2.7.1.1.1. Lights: sockets, LED track, switches. Ordering bulbs with a shelf is optional. There are multiple bulb styles available and bulbs show when adding sockets in the designer.
         2.7.1.1.2. Power: supply wire, USB ports, outlets
         2.7.1.1.3. Other: vases, hooks, and 3^{rd} party items. 3^{rd} party items are baubles/elements designed to integrate with Naui Shelf system. A standards document and compliance assistance will be provided to designers who wish to partner with Naui Designs.
         2.7.1.2. Non-point-objects include but not limited to:
         2.7.1.2.1. Doors which affix at the face of an edge
         2.7.1.2.2. Mirrors that fit into a channel (usually set to the back of an edge)
         2.7.1.2.3. Lexan/glass doors and panels
         2.7.1.2.4 In-line switches
         2.7.1.3. Choose from pre-selected aesthetic packages. E.g.:
         2.7.1.3.1. Medieval—heavy wood, distressed iron metal-wrap joints, decorative punched galvanized doors, inductive base votives
         2.7.1.3.2. Industrial—¾″ square steel bar on face of plywood edges, iron hinged doors, recessed LED-style lighting
         2.7.1.3.3. Lodge—cedar wood, cedar doors, oak peg cross dowel joints
         2.7.1.3.4. Coffee Shop—oak edges, LED Edison style bulbs
   2.8. Viewing shelf on wall
      2.8.1. A phone app will be designed that utilizes build in camera to overlay shelf rendering on wall in real time.
3. Customer initiates validation, load-balancing, and electric circuit optimization—Step 22
   3.1. At any time during design process, the design can be checked for unlikely layouts and combinations such as:
      3.1.1. A lone vertical edge which may have been left on accident.
      3.1.2. Designs that would require a single “floating shelf” bracket while the rest of the shelf is supported by Naui Designs spring cleat brackets.
      3.1.3. Multiple door materials on the same design.
      3.1.4. In addition to those warnings, validation will show optimized positions of support brackets and maximum weight on each shelf edge.
   3.2. Load-Balancing will generate optimal locations for support brackets given a standard load capacity per shelf.
      3.2.1. Customer can change modes between free standing and wall mounted (partially free-standing and partially mounted can also be accommodated).
      3.2.2. Customer can reject proposed positions by increasing load capacity or manually placing brackets.
      3.2.3. If brackets are manually placed, they will still need to pass minimum load bearing verification.
      3.2.4. There are obviously practical limits to the weight a Naui Shelf can hold to which no amount of adding brackets will help. It is suggested that televisions and anvils be mounted independently and the Naui Shelf be designed to fit around them.
      3.2.5. Very large designs can become cumbersome to hang; designer will recommend (but not enforce) breaking design into sections if it exceeds 50 lbs.
   3.3. Electric circuit optimization includes:
      3.3.1. Checking for obvious problems such as air gaps in circuit.
      3.3.2. Routing wires and allowing customer to change routes.
      3.3.3. Calculating circuit load and ensuring compliance with UL standards.
4. Customer accepts design and completes purchase. —Step 24
   4.1. When a design is validated and complete, measurements are given to check design on wall.
5. Server processes order and auto-generates documentation. —Step 26
   5.1. Custom Assembly Instructions
      5.1.1. Assembly instructions, parts lists, labels, a web-page and QR link are generated and attached to the order in database.
   5.2. Bill of materials.
   5.3. Stickers for each part.
   5.4. QR code link.
      5.4.1. Viewing/Editing privileges are set by creator.
      5.4.2. Designs can be “cloned” as a starting point for new shelves by viewers.
      5.4.3. View renderings on the shelf.
      5.4.4. Request technical support.
      5.4.5. Upload pictures.
      5.4.6. Share on social media for chances to win prize.
6. Human at Naui Designs verifies design and documentation. —Step 28
   6.1. A human at Naui Designs subjectively checks that the design seems valid. (User forgot to scale wall and door is 3 feet tall, etc.)
7. Naui Designs fills order. —Step 30
   7.1. Cut and label parts.
      7.1.1. All parts are cut, labeled, and shipped.
   7.2. Package and ship.

### II. Spring Cleats

In another aspect, a spring cleat is described herein. In some embodiments, a spring cleat comprises a housing having a first surface, a lever arm movably connected to the housing and spring biased toward the first surface of the housing in an extended position, and a hook attached to the lever arm. In such embodiments, the lever arm can be operable, upon application of a force in a first direction (such as a first direction that is opposite the first surface) upon the lever arm and/or the hook, to move away from the first surface of the housing towards a depressed position. For example, a spring cleat, as described herein, comprises a housing, a lever arm, and a hook. The housing has a first surface and a second surface. The lever arm is pivotally connected to the housing and is spring biased toward the first surface of the housing in an extended position. The hook is attached to the lever arm. The lever arm, upon application of a force opposite the first surface upon at least one of the lever arm and the hook, is operable to pivot away from the first surface of the housing towards a depressed position. In certain other embodiments, a spring cleat comprises a housing, a lever arm, and a hook. The housing comprises a first surface. The lever arm is slidably attached to the housing by a spring-rod and is spring biased toward the first surface of the housing in an extended position. The hook is attached to the lever arm. The lever arm, upon application of a force in a first direction opposite the first surface upon at least one of the lever arm and the hook, is operable to slide away from the first surface of the housing towards a depressed position of the housing.

Turning now to specific components, a spring cleat described herein comprises a housing. The housing can comprise or be formed from any material not inconsistent with the objectives of the present invention. In some embodiments, a housing comprises or is formed from metal. For example, in some cases, a housing described herein can comprise or be formed from aluminum, steel, titanium, nickel, chromium, cobalt, or alloys or mixtures thereof. In some embodiments, a housing comprises or is formed from a polymeric or plastic material, such as a polyethylene, a polypropylene, polyurethane, polyester or epoxy resin. Other hard plastic materials may also be used. Additionally, a housing of a spring cleat can comprise or include any number of sides in any configuration not inconsistent with the objectives of the present invention. For example, in some embodiments, a housing comprises a first surface and a second surface. Depending on the desired orientation of the spring cleat, the first surface can be a top surface or a bottom surface. For example, in the embodiments of FIGS. 2A-2D, the first surface is a top surface. It is to be understood, however, that if the spring cleat is desired to be used in an inverted configuration relative to what is illustrated in FIGS. 2A-2D, the first surface can be a bottom surface. A second surface of the housing can be a back surface. A “back” surface, as referenced herein, indicates a surface opposite one or more portions or surfaces of the spring cleat utilized in a clamping or hooking engagement. In the embodiment of FIGS. 2A-2D, the second surface (112) is a back surface disposed opposite a hook (130). A housing can further comprise additional surfaces. For example, in some embodiments, a housing described herein further comprises a third surface, a fourth surface, and a fifth surface. In such embodiments, the first, second, third, fourth and fifth surfaces can together form or define a cavity or a recess, as illustrated in FIGS. 2A-2D. A cavity defined by the surfaces of the housing can have any shape or configuration not inconsistent with the objectives of the present invention. For example, in the embodiment of FIGS. 2A-2D, a third surface is a bottom surface (which may be a top surface if the spring cleat is inverted) opposite the first surface, and the fourth and fifth surfaces are side surfaces disposed opposite one another. In some embodiments, the cavity defined by the surfaces is dimensioned to permit certain utility or usage of the spring cleat. For example, the cavity can be dimensioned to contain or receive all or substantially all of a hook and/or lever arm of the spring cleat.

A spring cleat described herein can further comprise or include a lever arm. The lever arm is pivotally connected to the housing. “Pivotally” connected, for reference purposes herein, indicates that the lever arm is connected, fastened, or otherwise attached to the housing with structure or in a manner permitting rotational movement or radial movement of the lever arm at a pivot point or along a pivot axis. Any structure or configuration not inconsistent with the objectives of the present invention can be used in order to permit such movement. For example, in some embodiments, the housing can comprise or include a pivot arm or a pivot joint which is adapted or configured to engage complementary structure on the lever arm to permit pivotal movement. In certain other embodiments, the lever arm can comprise or define a pivot channel adapted to receive a pivot pin. A pivot pin can be disposed within or passed through the pivot channel and engage the housing in order to place the lever arm and the housing in pivotal engagement. In some embodiments, the lever arm is spring biased towards one or more surfaces of the housing. For example, in some cases, the lever arm is spring biased toward the first surface, which may be a top surface or a bottom surface. Any structure or configuration may be provided not inconsistent with the objectives of the present invention in order to permit such functionality. For example, in some embodiments, as illustrated in FIGS. 2A-2D, a spring wire (140) is provided which engages the lever arm (120) and the back surface of the housing (110) to spring bias the lever arm (120) towards the first surface (111). A lever arm which is pivotally connected to the housing and spring biased towards a surface, such as the first surface, may therefore be operable to pivot away from the first surface upon application of a force opposite the first surface toward a depressed position. The lever arm can comprise or be formed from any material not inconsistent with the objectives of the present invention. In some embodiments, a lever arm comprises or is formed from metal. For example, in some cases, a lever arm described herein can comprise or be formed from aluminum, steel, titanium, nickel, chromium, cobalt, or alloys or mixtures thereof. In some embodiments, a lever arm comprises or is formed from a polymeric or plastic material, such as a polyethylene, a polypropylene, polyurethane, polyester or epoxy resin. Other hard plastic materials may also be used.

A spring cleat, in some embodiments, further comprises a hook attached to the lever arm. The hook can comprise or be formed from any material not inconsistent with the objectives of the present invention. In some embodiments, a hook comprises or is formed from metal. For example, in some cases, a hook described herein can comprise or be formed from aluminum, steel, titanium, nickel, chromium, cobalt, or alloys or mixtures thereof. In some embodiments, a hook comprises or is formed from a polymeric or plastic material, such as a polyethylene, a polypropylene, polyurethane, polyester or epoxy resin. Other hard plastic materials may also be used. In some embodiments, the hook comprises or is formed from the same material as the lever arm. In other embodiments, the hook comprises or is formed from a different material than the lever arm. The hook can be attached to the lever arm in any manner not inconsistent with the objectives of the present invention. For example, in some embodiments, the hook and the lever arm are monolithic or integrally formed. In certain other embodiments, the hook and the lever arm are permanently or non-permanently joined. The hook and the lever arm may have corresponding fastening or attachment structure, such as a male connector and a female connector, or an additional fastening component and/or an adhesive can be used. A hook described herein comprises an angled surface adapted or configured to engage with an additional structure or fixture. For example, in some embodiments, the hook is adapted or configured to engage a French cleat. One or more surfaces of the hook may be angled at a corresponding angle to the structure or fixture, or may be curved to have a corresponding shape to the structure or fixture.

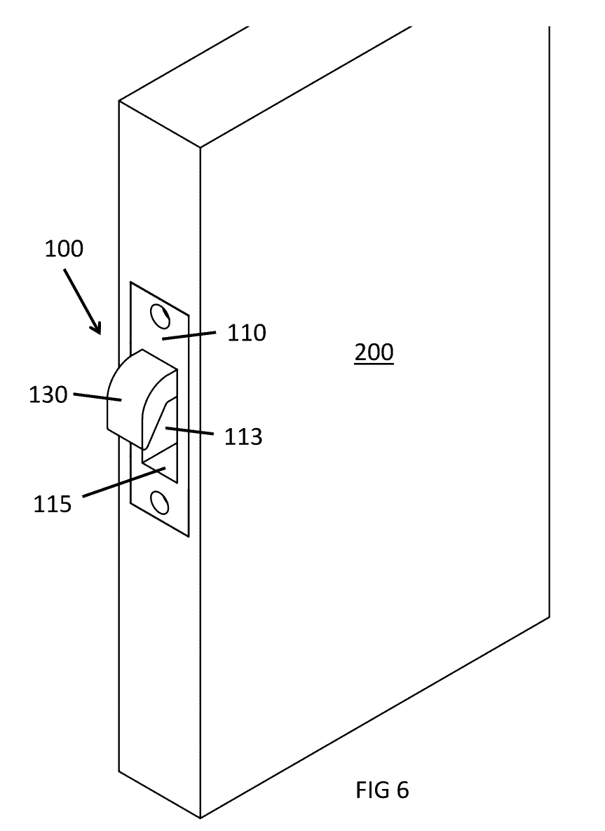

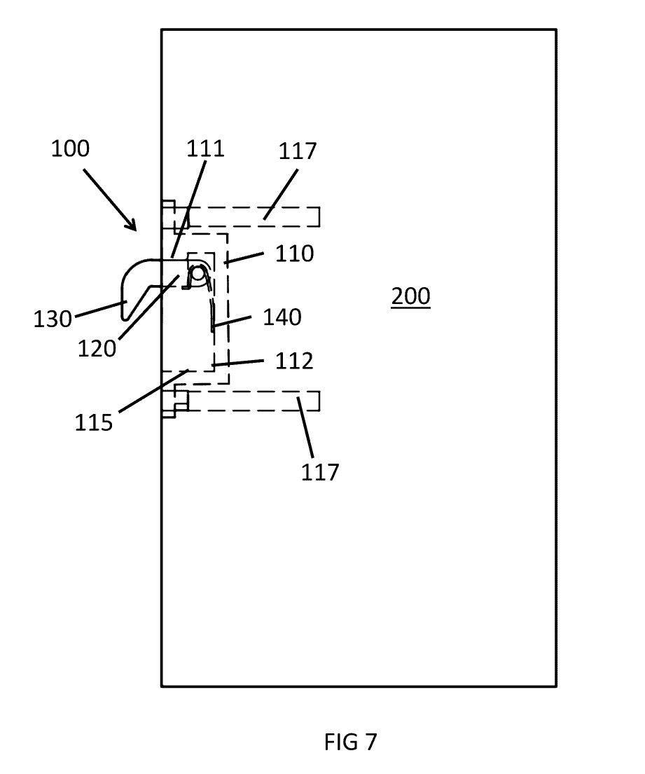

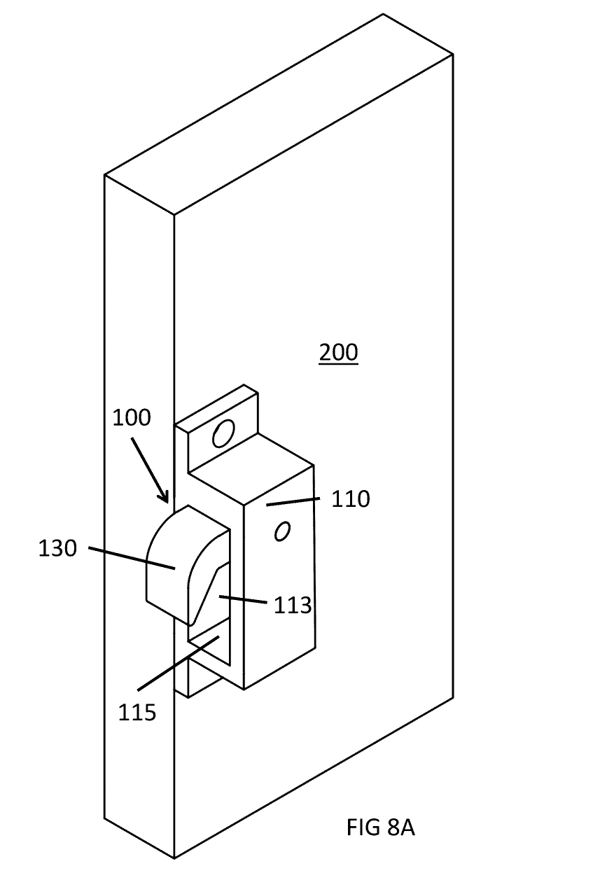

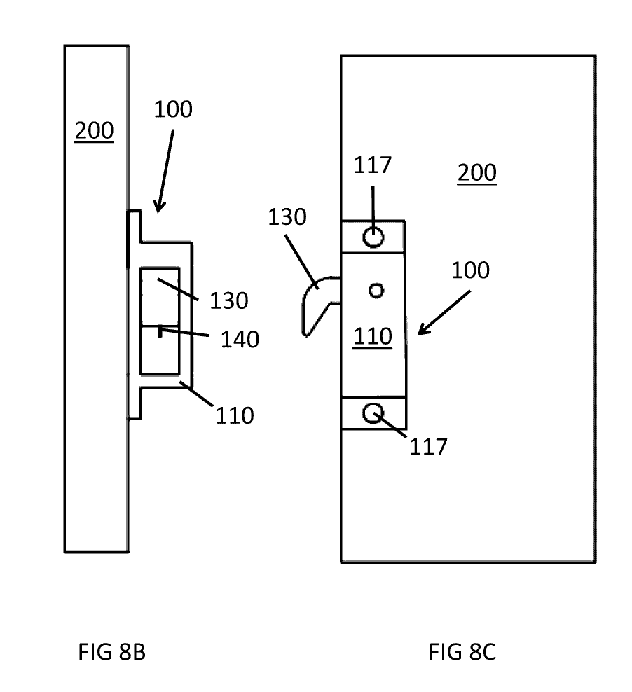

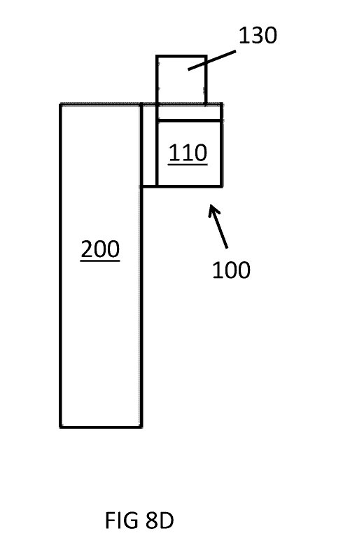

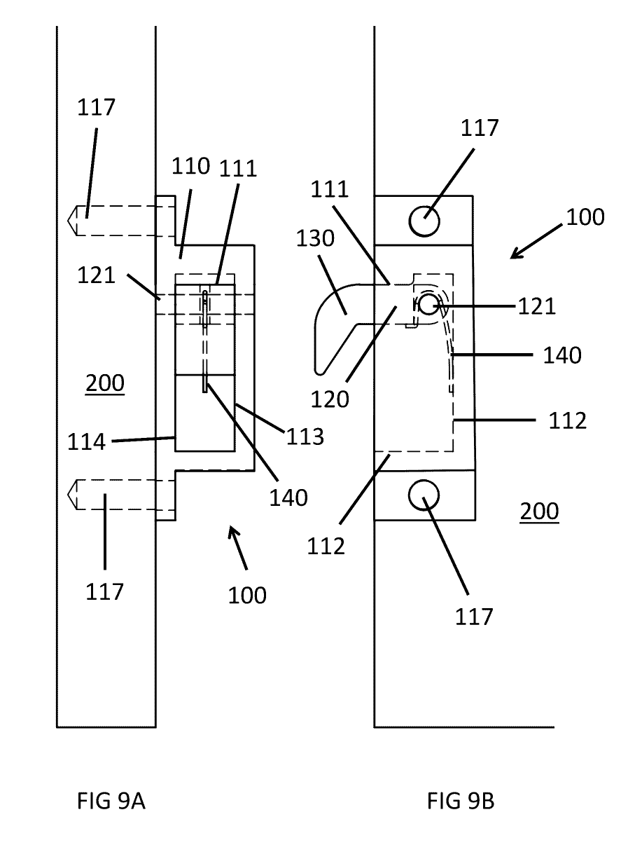

A spring cleat described herein can be adapted or configured to be fastened to a substantially vertical surface or to a fixture in any manner or by any means not inconsistent with the objectives of the present invention. For example, in some embodiments, the housing of the spring cleat is adapted to be fastened external to a substantially vertical surface or to a fixture. Any structure or configuration can be used to permit the spring cleat to be adapted to fasten externally to the substantially vertical surface or to the fixture. For example, the housing may define one or more holes or channels through which a bolt, pin or screw may be passed to attach the housing to the substantially vertical surface or to the fixture. One such embodiment is described further herein below with regard to FIGS. 8A-9B. Other configurations are also possible. In some embodiments, the spring cleat can be attached to the substantially vertical surface or to the fixture by an adhesive. In certain other embodiments, the housing is adapted to be recessed within a cavity defined by a substantially vertical surface or by a fixture. In such embodiments, all or substantially all of the housing of the spring cleat may be recessed within or otherwise disposed internal to the substantially vertical surface or to the fixture. Any structure or configuration not inconsistent with the objectives of the present invention can be used to permit such utility. For example, in some embodiments, one or more surfaces of the housing can define a through-hole or a channel adapted or configured to receive and/or engage a screw, bolt or pin in order to fasten or attach the housing to the substantially vertical surface or to the fixture. The substantially vertical surface or the fixture can define a recess which is of adequate or sufficient size to receive all or substantially all of the housing. In some embodiments, one or more surfaces of the housing can be flush with one or more surfaces of the substantially vertical surface or of the fixture. In such embodiments, the hook and/or a portion of the lever arm extend to be external to the substantially vertical surface or to the fixture in an extended position. Further, in some embodiments, the hook and/or the lever arm can be disposed within or substantially disposed within a cavity of the housing in a depressed position. Further description of one such embodiment is provided herein below in reference to FIGS. 6 and 7.

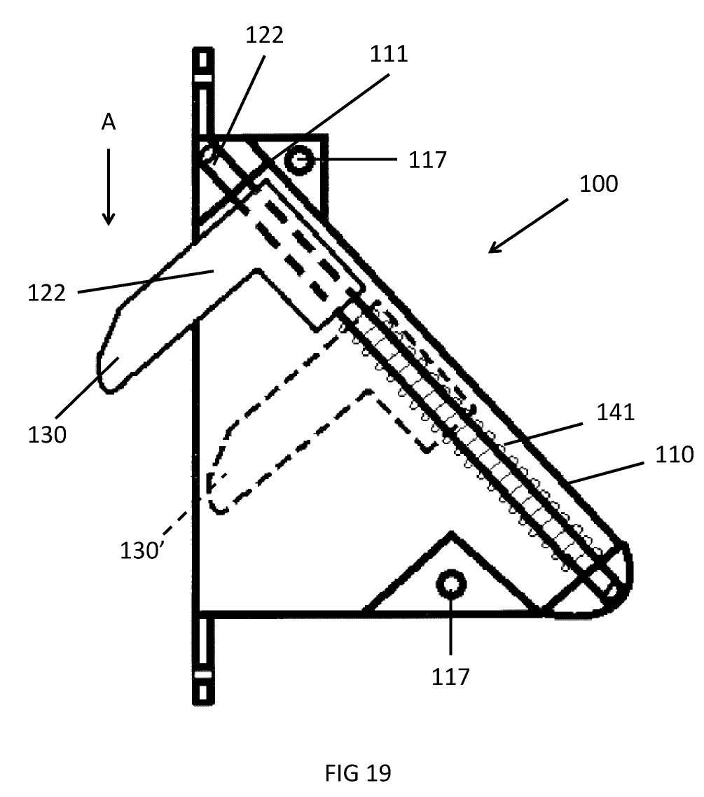

In some embodiments, a spring cleat comprises a spring rod. A spring rod described herein can comprise or be formed from any material not inconsistent with the objectives of the present invention. For example, a spring rod can comprise or be formed from aluminum, steel, titanium, nickel, chromium, cobalt, or alloys or mixtures thereof. In some embodiments, a spring rod comprises or is formed from a polymeric or plastic material, such as a polyethylene, a polypropylene, polyurethane, polyester or epoxy resin. Other hard plastic materials may also be used. The spring rod is adapted or configured to engage a spring surrounding or substantially surrounding the spring rod. The spring is operable to bias the lever arm and/or the hook towards an extended position as illustrated in FIG. 19. Any spring can be used having properties not inconsistent with the objectives of the present invention. The spring rod and/or the spring can be disposed on or within the spring cleat in any configuration not inconsistent with the objectives of the present invention. For example, in some embodiments, the spring rod and/or the spring cleat are disposed oblique relative to the substantially vertical surface or to an exterior surface of the fixture. In such embodiments, the spring rod and/or the spring can be arranged oblique relative to the surface or fixture to which the spring cleat is not attached prior to engaging the spring cleat with a corresponding French cleat or other cleat-like structure. In this manner, application of a force in a first direction (direction A in FIG. 19) can translate the hook and/or lever arm horizontally in addition to or instead of vertical translation in order to move the hook and/or lever arm into a depressed or retracted position. The spring biasing action can permit the hook and/or lever arm to return to the extended position against or toward the first surface after the force is removed from the hook and/or lever arm. Additionally, in certain other embodiments, the spring rod and/or spring are disposed normal to the surface against which the spring cleat is to be mounted when engaged with a French cleat or other cleat-like structure.

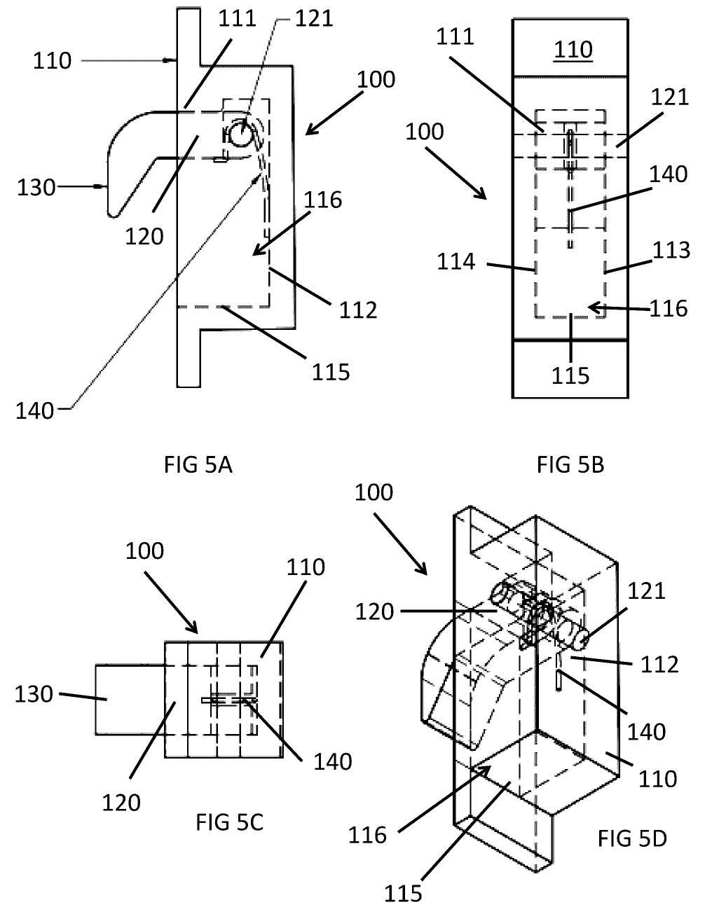

Some embodiments will now be further described with reference to the figures. FIGS. 4A and 4B illustrate perspective views of an example spring cleat according to one embodiment described herein. FIGS. 5A-5D illustrate perspective views of the embodiment of FIGS. 4A and 4B with one or more components being illustrated as transparent in order to better illustrate one or more internal components. In such embodiments, the spring cleat (100) comprises a housing (110) having a first surface (111) and a second surface (112). The spring cleat (100) further comprises a lever arm (120) pivotally connected to the housing (110) and spring biased toward the first surface (111) of the housing (110) in an extended position. A hook (130) is attached to the lever arm (120). The lever arm (120), upon application of a force opposite the first surface (111) upon at least one of the lever arm (120) and the hook (130) is operable to pivot away from the first surface (111) of the housing (110) towards a depressed position of the lever arm (120). The housing (110) further comprises a third surface (113), a fourth surface (114) and a fifth surface (115) which define a cavity (116). The cavity (116) is dimensioned to receive all or substantially all of the lever arm (120) and the hook (130) when the lever arm (120) is in the depressed position. The lever arm (120) is spring biased toward the first surface (111) by a spring wire (140) and is operable to pivot about the pivot pin (121).

FIGS. 6 and 7 illustrate another embodiment of a spring cleat described herein. In the embodiment of FIGS. 6 and 7, the spring cleat (100) is adapted to be mounted in a recess defined by a substantially vertical surface or a fixture (200). The housing (110) is attached or affixed to the substantially vertical surface/fixture (200) by a pin/bolt/screw (117).

FIGS. 8A-9B illustrate another embodiment of a spring cleat described herein. In the embodiments of FIGS. 8A-8D, one or more surfaces of the housing (110) directly abuts the substantially vertical surface/fixture (200). In the embodiment of FIGS. 8A-8D, the housing (100) defines two through-holes adapted or configured to engage a bolt, screw or pin (117) as illustrated in FIGS. 9A and 9B.

FIG. 19 illustrates an additional embodiment of a spring cleat described herein. In FIG. 19, a spring cleat (100) is provided which comprises a housing (110) having a first surface (111), a lever arm (120) and a hook (130) attached to the lever arm (120). The lever arm (120) is movably or slidably connected to the housing (110) by a spring rod (122) and is spring biased toward the first surface (111) of the housing (110) by a spring (141) such as a coil spring. As illustrated in FIG. 19, application of a force in a first direction (A) moves the hook (130) and lever arm (120) from an extended position (in solid lines for hook (130)) to a depressed position (indicated by the dashed lines of hook′ (130′)). Release or removal of the force in the first direction (A) opposite the first surface (111) permits the hook (130) to return to the extended position. Additionally, in FIG. 19, the spring rod (122) and the coil spring (141) are non-horizontal and non-vertical, which would be oblique to a surface against which the spring cleat (100) would be engaged when connected to a French cleat (not shown) or other cleat-like element (not shown).

### III. Systems for Hanging a Fixture Using a Spring Cleat

In a further aspect, a system of hanging a fixture from a substantially vertical surface is described herein. In some embodiments, a system described herein comprises a spring cleat which comprises a housing, a lever arm, and a hook. The housing has a first surface and a second surface. The lever arm is movably (e.g., pivotally or slidably) connected to the housing and can be spring biased toward the first surface of the housing in an extended position. The hook is attached to the lever arm. The lever arm, upon application of a force opposite the first surface upon at least one of the lever arm and the hook, is operable to move (e.g., pivot or slide) away from the first surface of the housing toward a depressed position of the lever arm.

Turning now to specific components, a system described herein comprises a spring cleat. Any spring cleat not inconsistent with the objectives of the present invention can be used. For example, a spring cleat consistent with the above discussion provided in Section II can be used. Such spring cleats can comprise or include a housing, a lever arm, and a hook. The housing can have a first surface and a second surface. In some embodiments, the lever arm is pivotally connected to the housing and is spring biased toward the first surface of the housing in an extended position. Alternatively, in other instances, the lever arm may be slidably connected to the housing. The hook is attached to the lever arm. Consistent with Section II above, the lever arm, upon application of a force opposite the first surface upon at least one of the lever arm and the hook, is operable to pivot away from the first surface of the housing towards a depressed position of the lever arm. Alternatively, as described above, the lever arm can be operable to slide away from the first surface of the housing towards a depressed position. Other manners of moving the lever arm towards a depressed position may also be used.

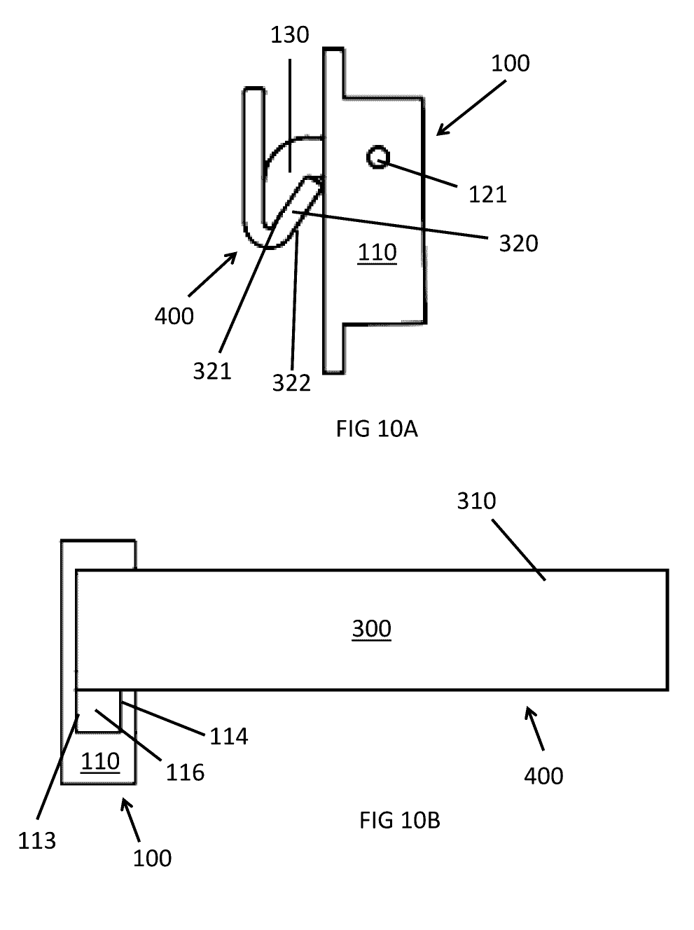

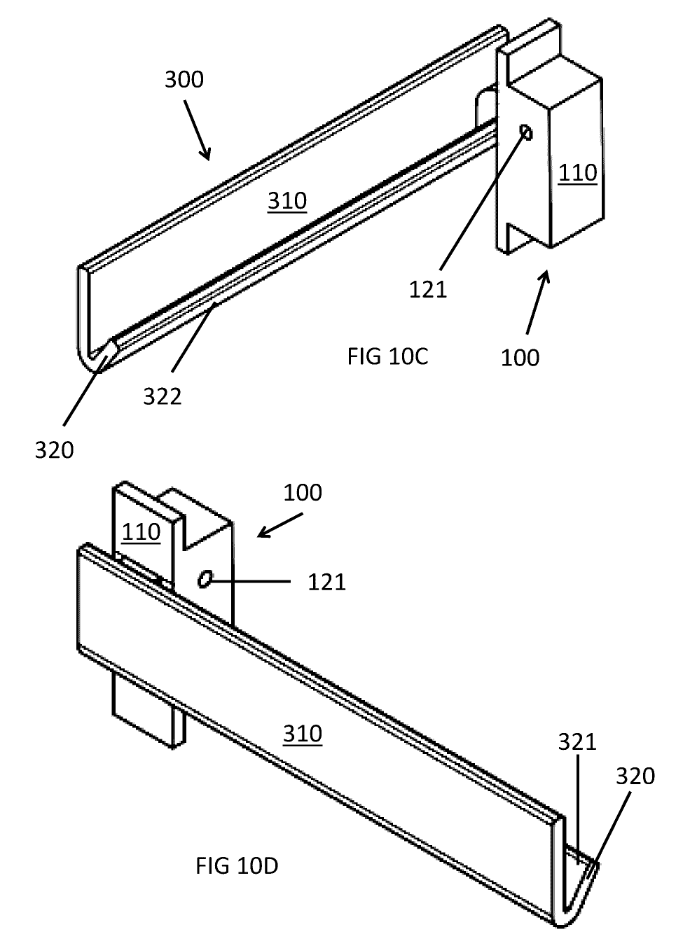

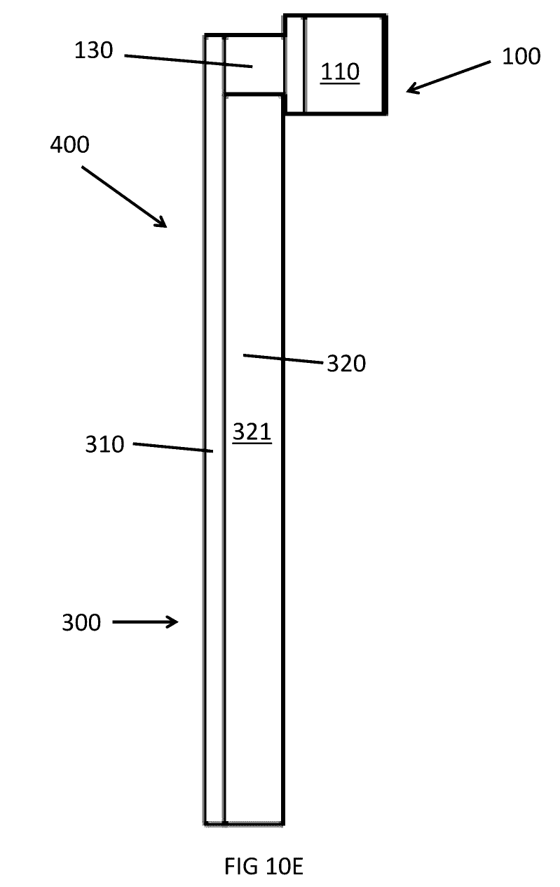

A system described herein can further comprise a French cleat operable to engage the hook of the spring cleat. Any French cleat not inconsistent with the objectives of the present invention. For example, in some embodiments, the French cleat defines a substantially vertical portion and a hook engaging portion oblique to the substantially vertical portion. In some embodiments, the hook-engaging portion can extend upward or downward, based upon a desired configuration of the French cleat relative to the spring cleat. For example, in the embodiments illustrated in FIGS. 10A-10E, the hook engaging portion extends upward. It is to be understood, however, that the spring cleat and the French cleat can be inverted and the hook-engaging would then extend downward. The French cleat can comprise or be formed from any material not inconsistent with the objectives of the present invention. In some embodiments, the French cleat comprises or is formed from the same or substantially the same material or materials as one or more components of the spring cleat. In certain other embodiments, the French cleat comprises or is formed from a different material than one or more components of the spring cleat. In some embodiments, a French cleat comprises or is formed from metal. For example, in some cases, a French cleat described herein can comprise or be formed from aluminum, steel, titanium, nickel, chromium, cobalt, or alloys or mixtures thereof. In some embodiments, a French cleat comprises or is formed from a polymeric or plastic material, such as a polyethylene, a polypropylene, polyurethane, polyester or epoxy resin. Other hard plastic materials may also be used. Further, in some embodiments, the French cleat comprises or is formed from wood or a wood composite.

The French cleat and/or the spring cleat may be adapted or configured to suspend or hang the fixture from the substantially vertical surface in any manner. For example, in some embodiments, the French cleat is fastened to the substantially vertical surface. In such embodiments, the housing of the spring cleat can be adapted to be disposed in a recess of the fixture or can be adapted to be fastened to an external surface of the fixture. Further, in some embodiments, the French cleat is fastened to the fixture. In some such embodiments, the French cleat is fastened to the fixture and is not fastened to the substantially vertical surface by any means in addition to the use of the spring cleat. Moreover, in such embodiments, the housing of the spring cleat can be adapted to be disposed in a recess of the substantially vertical surface or can be adapted to be externally fastened to the substantially vertical surface. The French cleat can be attached to the substantially vertical surface and/or the fixture in any manner. For example, in some embodiments, the French cleat is tacked, screwed, or bolted to the substantially vertical surface or to the fixture. In certain other embodiments, the French cleat is adhered to the substantially vertical surface or to the fixture.

Some embodiments will now be further described with reference to the figures. FIGS. 10A-10E illustrate varying perspective views of a system according to one embodiment described herein. The system (400) comprises a spring cleat (100) consistent with the configuration and components of the embodiment illustrated in FIGS. 4A-5D and described herein above. The system (400) further comprises a French cleat (300) operable to engage the hook (130) of the spring cleat (100). The French cleat (300) defines a substantially vertical portion (310) and a hook-engaging portion (320) oblique to the substantially vertical portion (310). The hook-engaging portion (320) comprises a first side (321) and a second side (322), the first side (321) facing the substantially vertical surface (not shown) when the French cleat (300) is attached to the substantially vertical surface and to facing the fixture (not shown) when the French cleat (300) is attached to the fixture. The second, side (322) faces away from the first side (321).

### IV. Methods of Hanging a Fixture Using a Spring Cleat

In a yet further aspect, a method of hanging a fixture from a substantially vertical surface is described herein. In some embodiments, a method described herein comprises providing a spring cleat. Any spring cleat described hereinabove in Section II may be used. A spring cleat can comprise a housing, a lever arm, and a hook. The housing has a first surface and a second surface. The lever arm is movably (e.g., pivotally or slidably) connected to the housing and is spring biased toward the first surface of the housing in an extended position. The hook is attached to the lever arm. The lever arm, upon application of a force opposite the first surface upon at least one of the lever arm and the hook, is operable to move (e.g., pivot or slide) away from the first surface of the housing towards a depressed position. The method further comprises providing a French cleat operable to engage the hook of the spring cleat. The French cleat has a substantially vertical portion and a hook-engaging portion oblique to the substantially vertical portion. The hook-engaging portion has a first side and a second side, the first side being adapted to face the substantially vertical surface when the French cleat is fastened to the substantially vertical surface and to face the fixture when the French cleat is fastened to the fixture. The second side faces in an opposite direction of the first side. The method can further comprise positioning the hook of the spring cleat proximate to the second side of the French cleat and moving the spring cleat and the French cleat relative to one another. Moving the spring cleat and the French cleat relative to one another can: first cause the second surface of the French cleat to apply force to the lever arm to cause the lever arm to move (e.g., pivot or slide) towards the depressed position; then cause the lever arm to move (e.g., pivot or slide) towards the extended position; and then engage the first surface of the French cleat with the hook of the spring cleat.

Turning now to specific steps and/or components, a method described herein comprises providing a spring cleat. Any spring cleat not inconsistent with the objectives of the present invention can be used. For example, a spring cleat consistent with the above description in Section II can be used. Such a spring cleat can comprise a housing, a lever arm, and a hook. The housing has a first surface and a second surface. The lever arm is movably (e.g., pivotally or slidably) connected to the housing and is spring biased toward the first surface of the housing in an extended position. The hook is attached to the lever arm. The lever arm, upon application of a force opposite the first surface upon at least one of the lever arm and the hook, is operable to move (e.g., pivot or slide) away from the first surface of the housing towards a depressed position of the lever arm. Providing the spring cleat may be performed in any manner not inconsistent with the objectives of the present invention. For example, in some embodiments, providing the spring cleat comprises fastening the housing of the spring cleat to the fixture. In such embodiments, the spring cleat can be fastened to an external surface of the fixture or can be disposed within a recess defined by the fixture. In certain other embodiments, providing the spring cleat comprises fastening the spring cleat to the substantially vertical surface. For example, in some such embodiments, the spring cleat is externally fastened to the substantially vertical surface or is disposed within a recess defined by the substantially vertical surface. The spring cleat can be attached to, fastened to, or disposed on or within the substantially vertical surface and/or the fixture in any manner not inconsistent with the description herein above in Sections II and III.

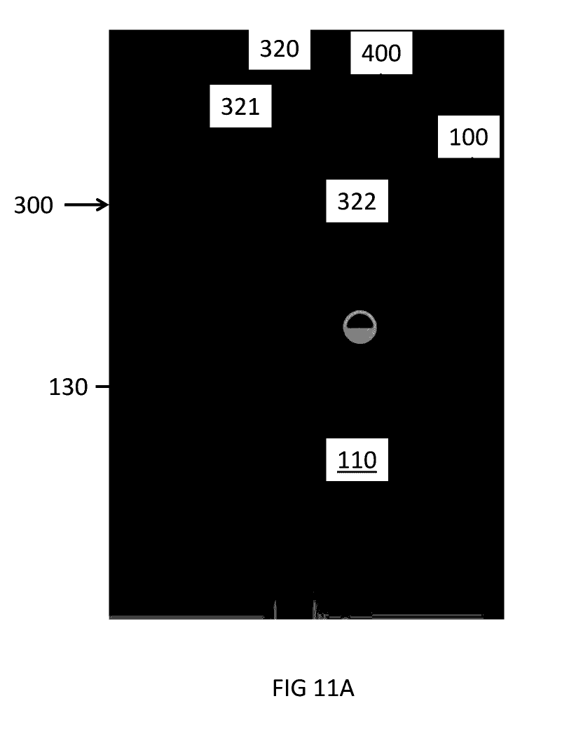

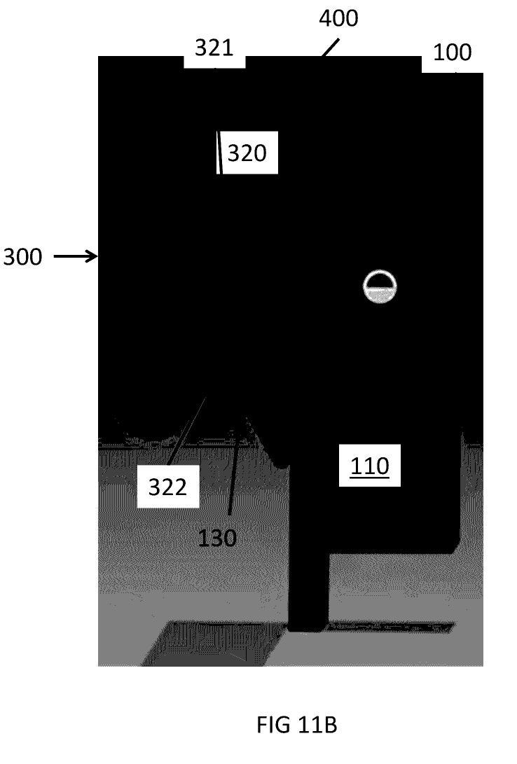

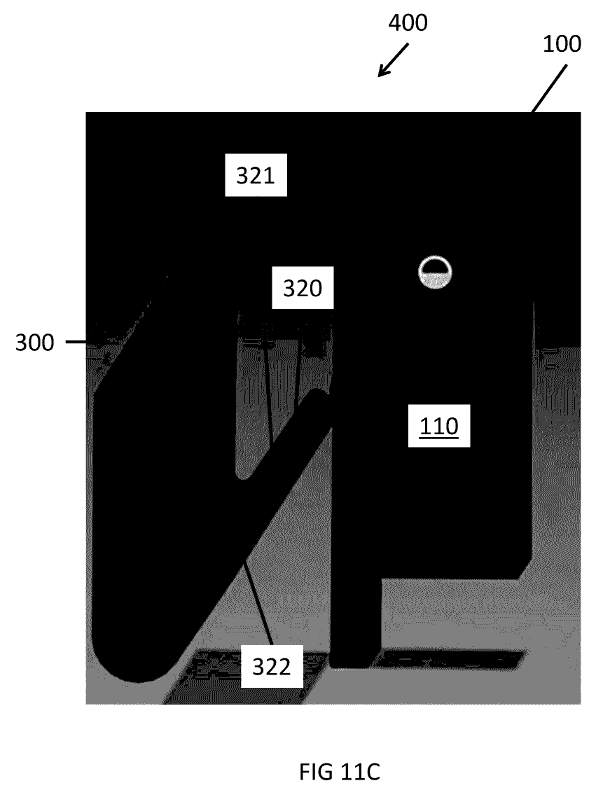

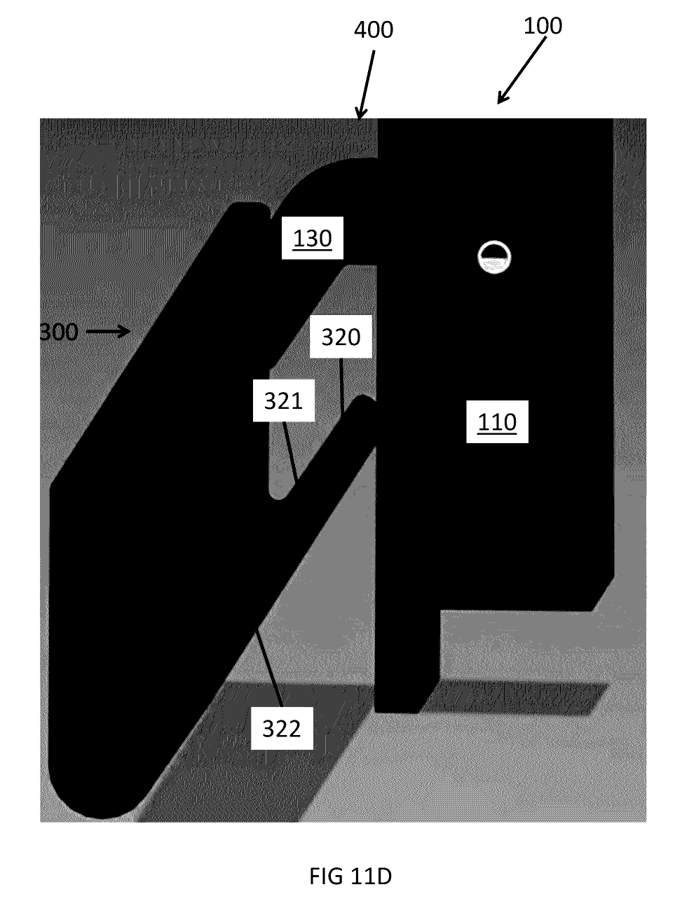

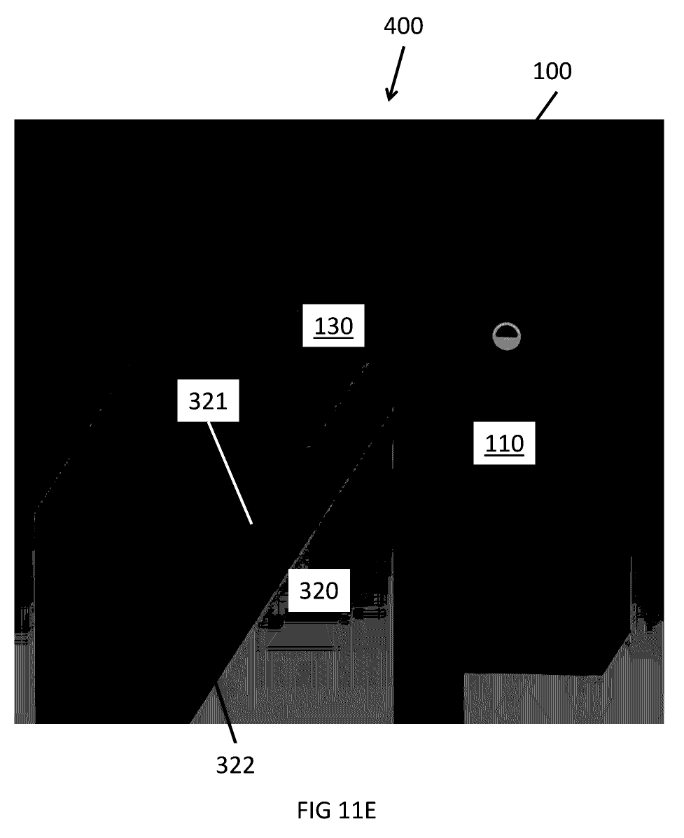

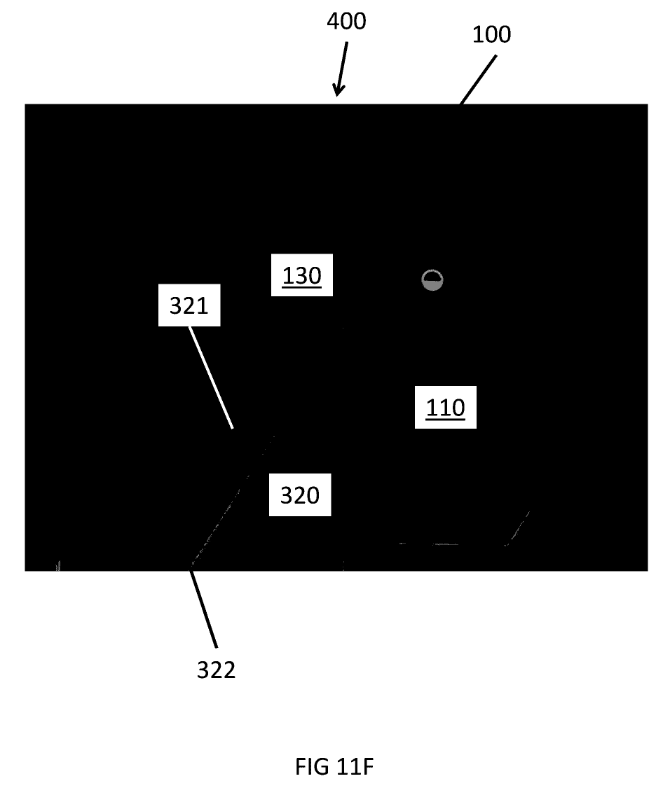

A method described herein further comprises providing a French cleat operable to engage the hook of the spring cleat. Any French cleat can be used not inconsistent with the objectives of the present invention. For example, in some embodiments, a French cleat consistent with the description provided herein above in Section III can be used. Thus, in some embodiments, the French cleat has a substantially vertical portion and a hook-engaging portion having a first side and a second side. The first side of the French cleat is adapted to face the substantially vertical surface when the French cleat is fastened to the substantially vertical surface and to face the fixture when the French cleat is fastened to the fixture. The second side faces in an opposite direction of the first side. Providing the French cleat can be performed in any manner. For example, in some embodiments, providing the French cleat comprises fastening the French cleat to the substantially vertical surface. In such embodiments, the French cleat can be fastened to the substantially vertical surface by the substantially vertical portion. In certain other embodiments, providing the French cleat comprises fastening the French cleat to the fixture. It is to be understood that the French cleat and the spring cleat may be disposed on opposing objects or surfaces. For example, in embodiments in which the French cleat is fastened to or attached to the substantially vertical surface, the spring cleat can be fastened to or attached to the fixture. Further, in embodiments in which the French cleat is fastened to or attached to the fixture, the spring cleat can be fastened to or attached to the substantially vertical surface. Moreover, it is to be understood that the position and/or arrangement of the hook of the spring cleat and the hook-engaging portion of the French cleat may be oriented relative to one another. Thus, the hook can be adapted to engage the French cleat from above or below the French cleat. The French cleat, in such embodiments, may have a hook-engaging portion that is oriented in an upward facing manner, as in FIGS. 11A-11F. In an alternative arrangement, the French cleat may have a downward facing hook-engagement portion, and the hook may be adapted to engage the French cleat from below (not shown).

Methods described herein further comprise positioning the hook of the spring cleat proximate to the second side of the French cleat. “Proximate,” for reference purposes herein, can refer to a distance that is close to, or in proximity to, the French cleat without being in contact with or engaging the French cleat. For example, the hook of the spring cleat, in some embodiments, is proximate the second side of the French cleat at a distance of between about 0.5 inches and about 12 inches. A list of ranges in which the hook and the second side of the French cleat may be proximate one another is provided in Table I below.

```
TABLE I
Distance (in.)
  2-10
3-6
0.5-6
2-8
  6-12
```

Methods described herein can also comprise moving the spring cleat and the French cleat relative to one another to enact one or more actions or to permit one or more additional movements or actions to be carried out. For example, in some embodiments, moving the spring cleat and the French cleat relative to one another first causes the second surface of the French cleat to apply force to the lever arm to cause the lever arm to move (e.g., pivot or slide) towards the depressed position. Further, in some such embodiments, moving the spring cleat and the French cleat then causes the lever arm to move (e.g., pivot or slide) towards the extended position. Additionally, in some cases, continuing to move the spring cleat and the French cleat relative to one another then engages the first surface of the French cleat with the hook of the spring cleat. Such step may be achieved by moving the spring cleat and/or the French cleat in an opposite direction or directions relative to an initial movement as described further herein below in reference to the figures.

One embodiment of a method described herein will now be further described with reference to the figures. FIGS. 11A-11F illustrate a perspective view of a method according to one embodiment described herein. In FIG. 11A, a spring cleat (100) having components consistent with those illustrated in FIGS. 4A-5D and described herein above is placed proximate a French cleat (300) having components illustrated in 10A-10E and described further herein above. In FIG. 11B, the spring cleat (100) and French cleat (300) are moved relative to one another to first cause the second surface or second side (322) of the French cleat (300) to apply force to the lever arm (120) to cause the lever arm (120) to pivot towards the depressed position. 11C illustrates a continuation of such relative movement and application of force to the lever arm (120) to the depressed position. FIG. 11D illustrates moving the spring cleat (100) and the French cleat (300) relative to one another to cause the lever arm (120) to pivot towards the extended position, an action which can occur after continued movement of the spring cleat (100) and the French cleat (300) in the initial direction of movement. FIG. 11E illustrates that the spring cleat (100) and the French cleat (300) can then be moved relative to one another opposite the initial directions to bring the hook (130) closer to the first surface or first side (321) of the French cleat (300). FIG. 11F illustrates a final position after continued movement of the spring cleat (100) and the French cleat (300) relative to one another to engage the first surface (321) of the French cleat (300) with the hook (130) of the spring cleat (100).

### V. Systems for Electrically Wiring a Joined Panel Assembly

In an additional aspect, systems for electrically wiring a joined panel assembly are described herein. In some embodiments, a system for electrically wiring a joined panel assembly described herein comprises a first panel, a second panel, a first power connector, and a second power connector. The first power connector is attached to the first panel and is flush with at least one surface of the first panel. The second power connector is attached to the second panel and is flush with at least one surface of the second panel. The second power connector is adapted to electrically connect to the first power connector. Further, the first panel and the second panel are adapted to abut and form a joint, the joint defining an angle θ greater than 0° and less than 180°.

Turning now to specific components, a system for electrically wiring a joined panel assembly described herein comprises a first panel and a second panel. Panels used in systems described herein can comprise or be formed from any material not inconsistent with the objectives of the present invention. For example, a first panel and/or a second panel can comprise or be formed from wood, a wood composite, particle board, fiber board, metal, a metal composite, and/or a polymeric or plastic material, such as a polyethylene, a polypropylene, polyurethane, polyester or epoxy resin. In some embodiments, one or more of the first panel and the second panel can comprise or form part or all of an item of furniture or a storage device such as a shelf or shelves, a wardrobe, pantry or the like. In some embodiments, one or more of the first panel and/or the second panel can comprise or include side and/or back panels of an item of furniture or of a storage device. The first panel and the second panel are adapted to abut and form a joint, the joint defining an angle θ greater than 0° and less than 180°. The angle θ can have any value or range of values not inconsistent with the objectives of the present invention. For example, in some embodiments, the joint defines an angle θ between about 75° and about 105°. Additional ranges of values for θ are provided herein below in Table II.

TABLE II
Value of θ (°)
10-170
20-160
30-150
45-135
60-120

In addition, first and/or second panels described herein can comprise or include additional components, structures, channels, receptacles and/or architecture adapted or configured to accommodate additional components or functionality. For example, in some embodiments, a first and/or a second panel comprises at least one electrical outlet or structure operable to receive or engage an electrical outlet. For example, in some embodiments, a first panel and/or a second panel defines a hole shaped or dimensioned to receive an electrical outlet. Further, in some embodiments, a first panel comprises or defines a first channel. A first channel can receive or engage a first wire disposed therein. The first wire can be electrically connected to or can be adapted to be electrically connected to one or more of the first power connector and/or an electrical outlet attached to the first panel. Similarly, the second panel can comprise or define a second channel that can receive or engage a second wire disposed therein. The second wire can be electrically connected to or can be adapted to be electrically connected to one or more of the second power connector and/or an electrical outlet attached to the second panel. In some embodiments, the first channel is disposed relative to the second channel at the angle θ.

First and/or second panels can be adapted or configured to be mounted to one or more objects or surfaces. For example, in some embodiments, the first panel is adapted to be mounted to a wall, a substantially vertical surface, or to a fixture by a back surface of the first panel. In such embodiments, the first power connector can be flush with the back surface of the first panel. As described further herein below, the first power connector can also be flush with at least one additional surface of the first panel for a total of two surfaces, or at least two additional surfaces for a total of three surfaces. Additionally, in some embodiments, the second panel comprises a top surface and a bottom surface. One of the top surface and the bottom surface can be configured to abut and/or engage one or more surfaces of the first panel. In such embodiments, the second power connector can be flush with at least the bottom surface. In addition, the second power connector, in some embodiments, is flush with at least one surface in addition to the bottom surface for a total of at least two surfaces of the second panel.

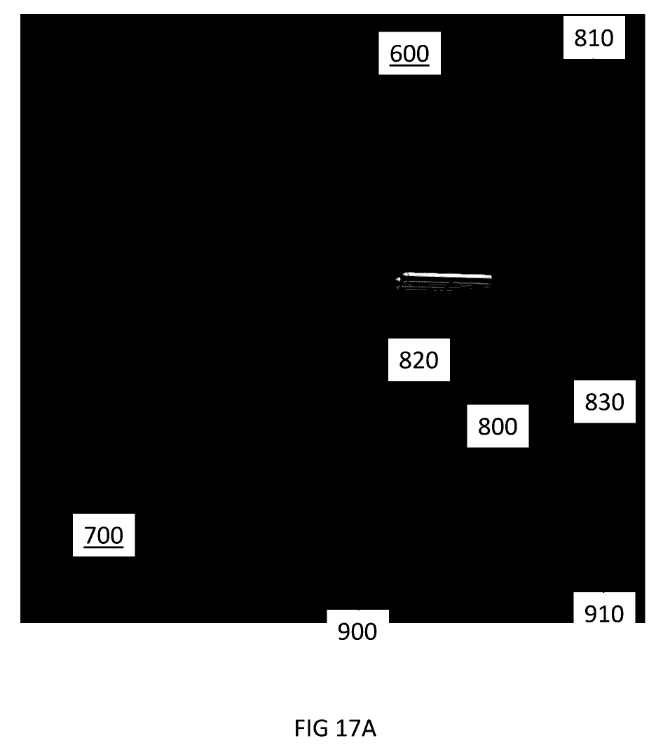

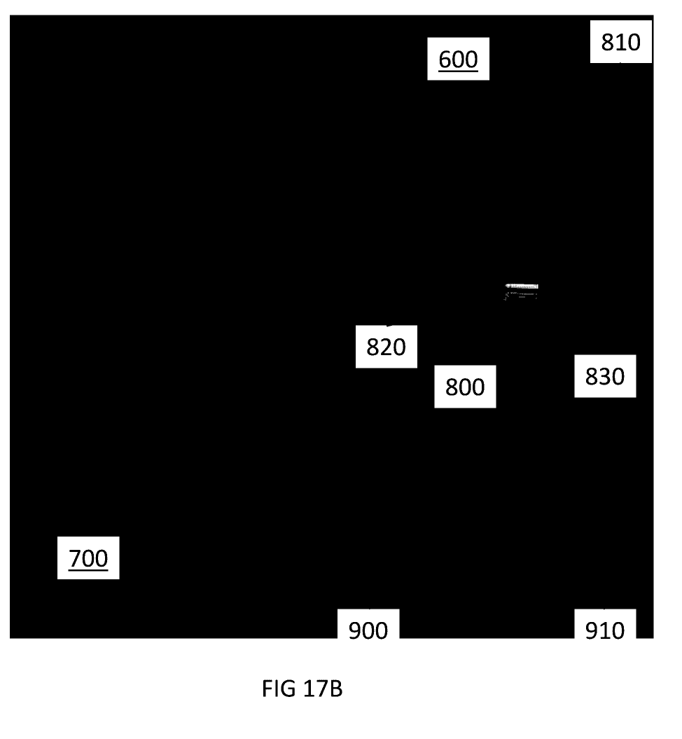

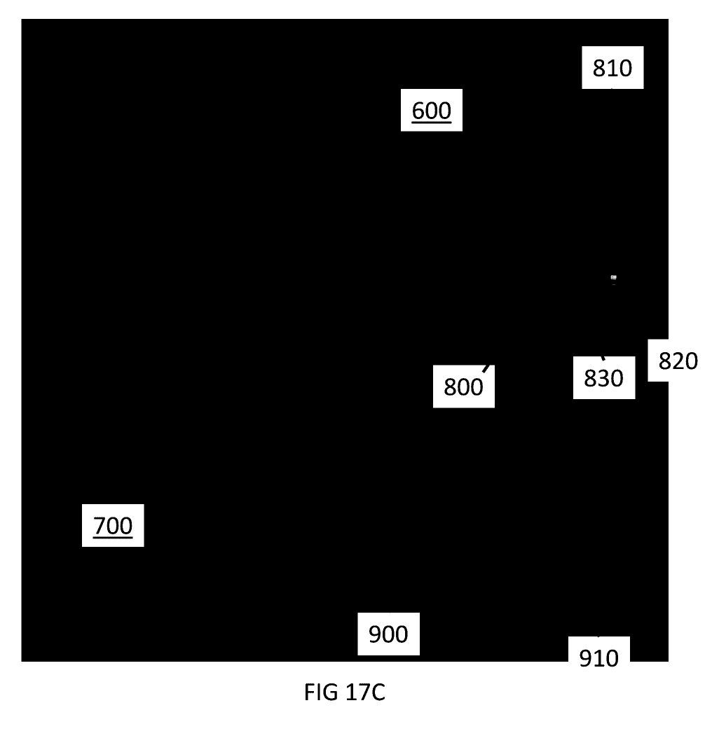

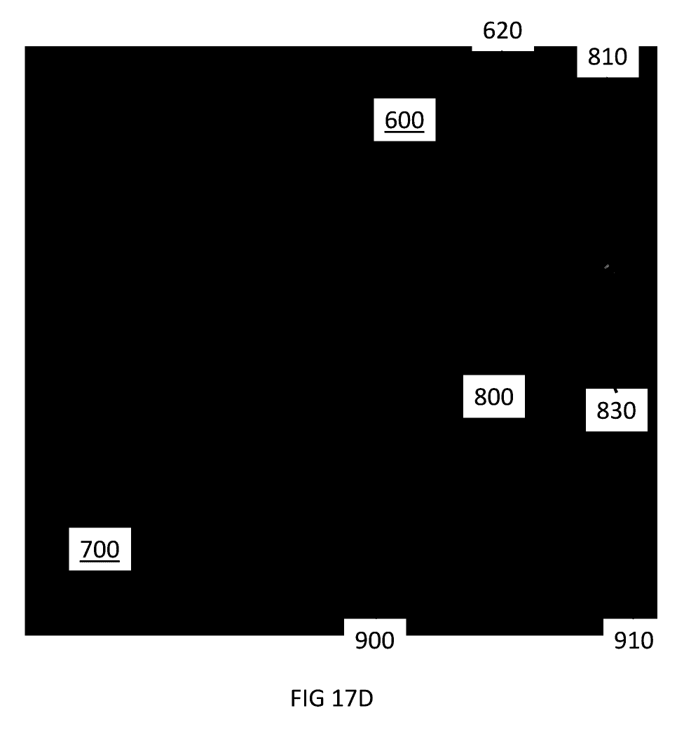

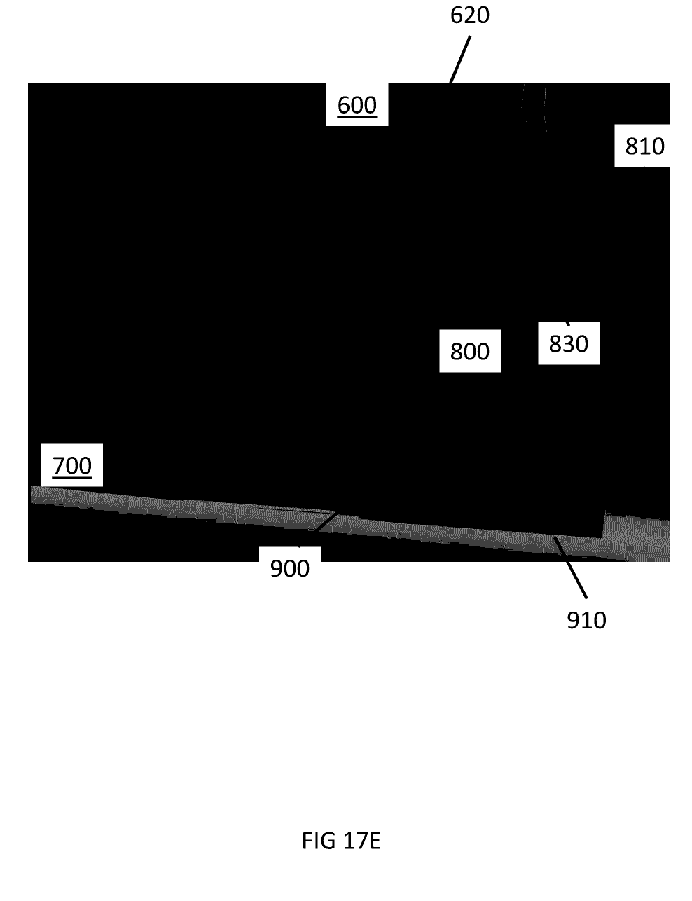

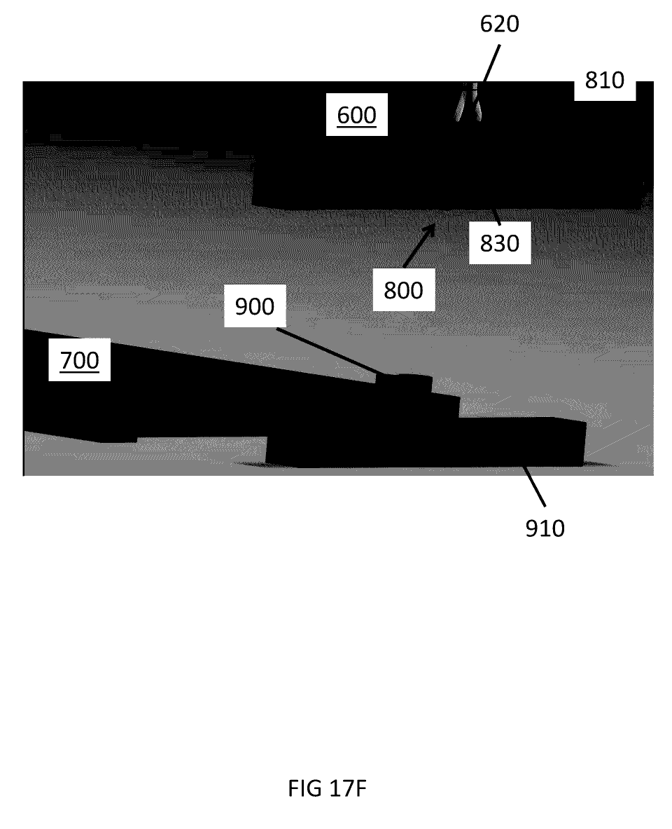

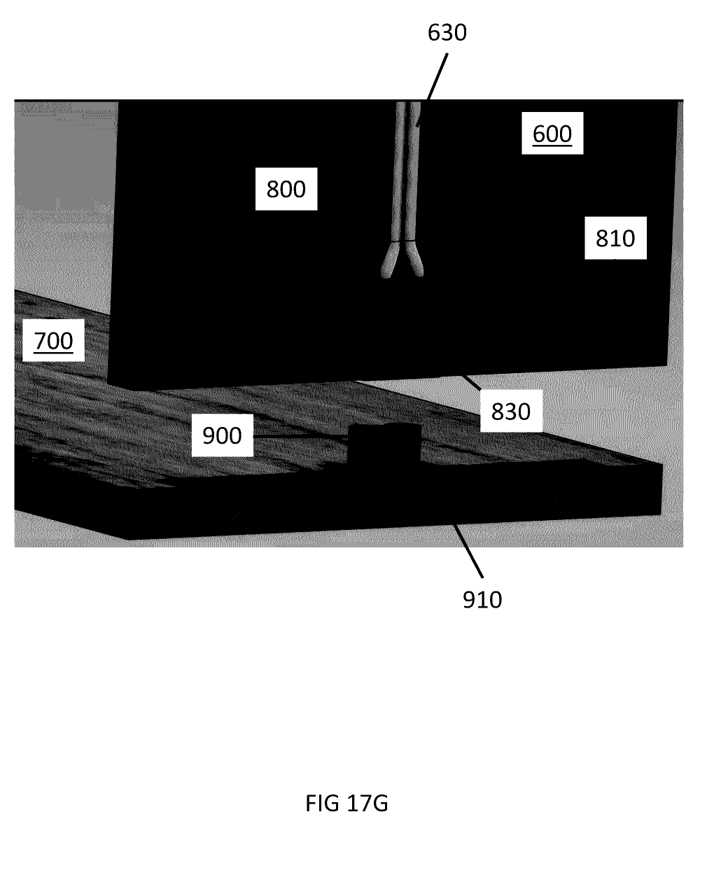

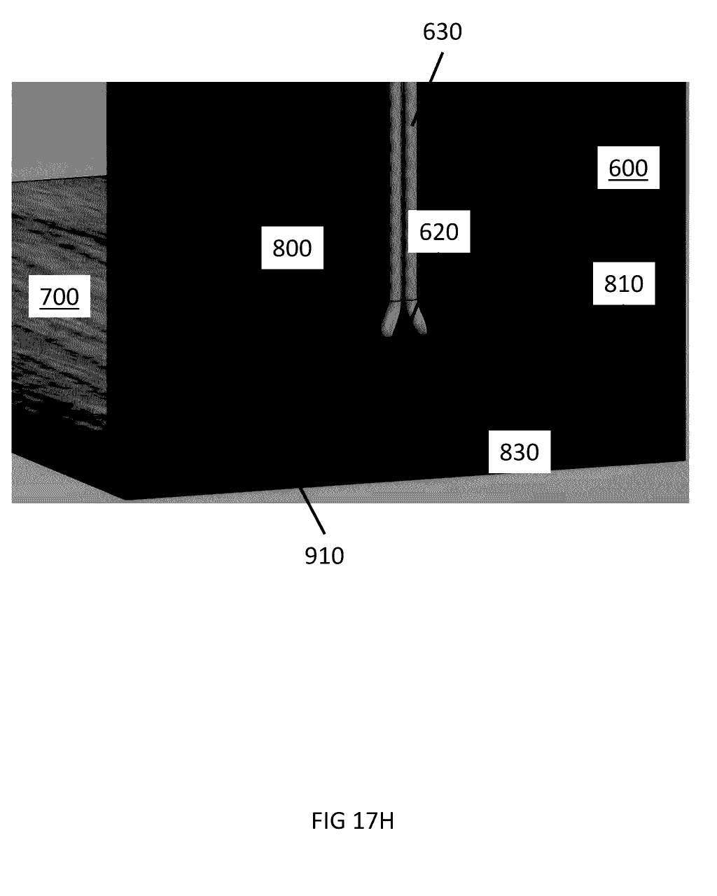

In addition, a system described herein can further comprise a first power connector. The first power connector can comprise or include any components in any configuration not inconsistent with the objectives of the present invention. In particular, the first power connector can have components in a configuration permitting or enabling connection of one or more first wires to an additional electrical component such as a second power connector. In some cases, a first power connector is a male power connector. In certain other embodiments, a first power connector is a female power connector. A first power connector, in some embodiments, comprises one or more conductive elements and one or more insulating elements. Conductive elements can comprise or be formed from any material or combination of materials operable to conduct electricity such as a metal or metal alloy. The insulating element or elements can surround or substantially surround the conductive elements to electrically shield or insulate the conductive elements from external damage or contact. The first power connector is attached to the first panel. The first power connector can be attached to the first panel in any manner or by any means not inconsistent with the objectives of the present invention. In some embodiments, the first power connector is attached to the first panel by a first connector housing. In certain other embodiments, the first power connector is attached directly to the first panel. The first power connector is flush with at least one surface of the first panel. “Flush,” for reference purposes herein, indicates that two or more surfaces are level, substantially level, even or substantially even with one another. In some embodiments, the first power connector is flush with at least two surfaces of the first panel. In some embodiments, the first power connector is flush with at least three surfaces of the first panel. In some such embodiments, the first panel defines or comprises a keyed recess or channel shaped and/or dimensioned to fit the first power connector. In such embodiments, a net shape of the first panel, first power connector, and (if present) first power connector housing can be the same or substantially the same as the first panel if no such keyed recess or channel were presented. FIGS. 17A-17H illustrate one such embodiment.

In some embodiments, a system described herein comprises a first connector housing. A first connector housing described herein can comprise or be formed from any material not inconsistent with the objectives of the present invention. In some embodiments, the first connector housing comprises or is formed from an electrically insulating material such as a rubber, a plastic, and/or a wood or wood composite. A first connector housing can have any shape or configuration not inconsistent with the objectives of the present invention. For example, in some embodiments, the first connector housing is flush with at least one surface of the first panel, is flush with at least two surfaces of the first panel, and/or is flush with at least three surfaces of the first panel.

Systems described herein can further comprise a second power connector. The second power connector is adapted to electrically connect to the first power connector. In addition, the second power connector is attached to the second panel and is flush with at least one surface of the second panel. In some embodiments, the second power connector is attached directly to the second panel. In certain other embodiments, the second power connector is attached to the second panel by a second connector housing. The second connector housing can have any of the properties, shapes, or configurations present in the first connector housing, and may be adapted separately for the particular shape and/or dimensions of the second panel and/or the second power connector. Thus, the second connector housing can be flush with at least one surface, at least two surfaces, or at least three surfaces of the second panel.

In addition, in some embodiments, a system described herein can comprise or include at least a third panel and a third power connector. In such embodiments, the first panel can be adapted or configured to abut and/or engage the second panel and the third panel, and the first power connector can be adapted or configured to electrically connect to the second power connector and to the third power connector. Similar to the first power connector and/or the second power connector, the third power connector can be flush with at least one surface, at least two surfaces, or at least three surfaces of the third panel. The third power connector can be attached directly to the third panel, or can be attached to a third connector housing, the third connector housing being attached directly to the third panel. In embodiments comprising a third panel, the first panel and the third panel can abut and/or engage to form a joint defining an angle θ₂ greater than 0° and less than 180°. A value for θ₂ can be between about 75° and about 105°, or can be chosen from Table II herein above. In some embodiments, the angle θ₂ has the same or substantially the same value as the angle θ. In certain other embodiments, the angle θ₂ has a different value than the angle θ. In some embodiments, a third panel is abutted to the first panel at an angle of about 0° or about 180°. In such embodiments, the third panel may be disposed relative to the second panel at an angle greater than 0° and less than 180°. The third power connector can comprise any components and can comprise or be formed from any materials consistent with first and/or second power connectors described herein. Further, the third panel can have any shape or configuration and can comprise or be formed from any materials consistent with first and/or second panels described herein. In some embodiments, the third panel defines a channel adapted or configured to receive or engage one or more wires, such as a third wire. Further, in some embodiments, the third panel comprises an electrical outlet or defines one or more holes adapted or configured to receive or engage an electrical outlet.

Moreover, in some embodiments, a system described herein comprises or includes more than three panels, power connectors, and/or connector housings. For instance, in some cases, a system described herein can comprise or include at least a fourth panel and a fourth power connector. In such embodiments, the first panel can be adapted or configured to abut and/or engage the second panel, the third panel, and the fourth panel, and the first power connector can be adapted or configured to electrically connect to the second power connector, the third power connector, and the fourth power connector. Similar to the first power connector, the second power connector, and/or the third power connector, the fourth power connector can be flush with at least one surface, at least two surfaces, or at least three surfaces of the fourth panel. The fourth power connector can be attached directly to the fourth panel, or can be attached to a fourth connector housing, the fourth connector housing being attached directly to the fourth panel. In embodiments comprising a fourth panel, the first panel, the second panel, and/or the third panel can abut and/or engage the fourth panel to form a joint defining an angle θ₃ having any value not inconsistent with the objectives of the present invention. For instance, in some cases, θ₃ is greater than 0° and less than 180°, between about 75° and about 105°, or chosen from Table II herein above. In some embodiments, the angle θ₃ has the same or substantially the same value as the angle θ or θ₂. In certain other embodiments, the angle θ₃ has a different value than the angle θ and/or or θ₂. Additionally, the fourth power connector can comprise any components and can comprise or be formed from any materials consistent with first, second, and/or third power connectors described herein. Further, the fourth panel can have any shape or configuration and can comprise or be formed from any materials consistent with first, second, and/or third panels described herein. In some embodiments, the fourth panel defines a channel adapted or configured to receive or engage one or more wires, such as a fourth wire. Further, in some embodiments, the fourth panel comprises an electrical outlet or defines one or more holes adapted or configured to receive or engage an electrical outlet.

It is to be understood that a system comprising three, four, or more panels can be modified to provide various shapes, configurations, or orientations of an electrically connected shelving or storage system consistent with the objectives of the present invention by utilizing varying numbers, shapes, and/or configurations of panels, power connectors, and/or connector housings.

Further, as described above, the second, third, and fourth panels are described as each abutting the first panel, such as on a first end of the first panel. However, it is further to be understood that, in certain other embodiments, a system described herein comprises a fifth, sixth, and/or seventh panel and fifth, sixth, and/or seventh power connected to and/or abutting the first panel at a second end of the first panel. Such a “second set” of panels at the second end of the first panel can have any configuration or structure described hereinabove for the second, third, and fourth panels. In this manner, complex electrically wired shelving and/or storage assemblies can be wired.

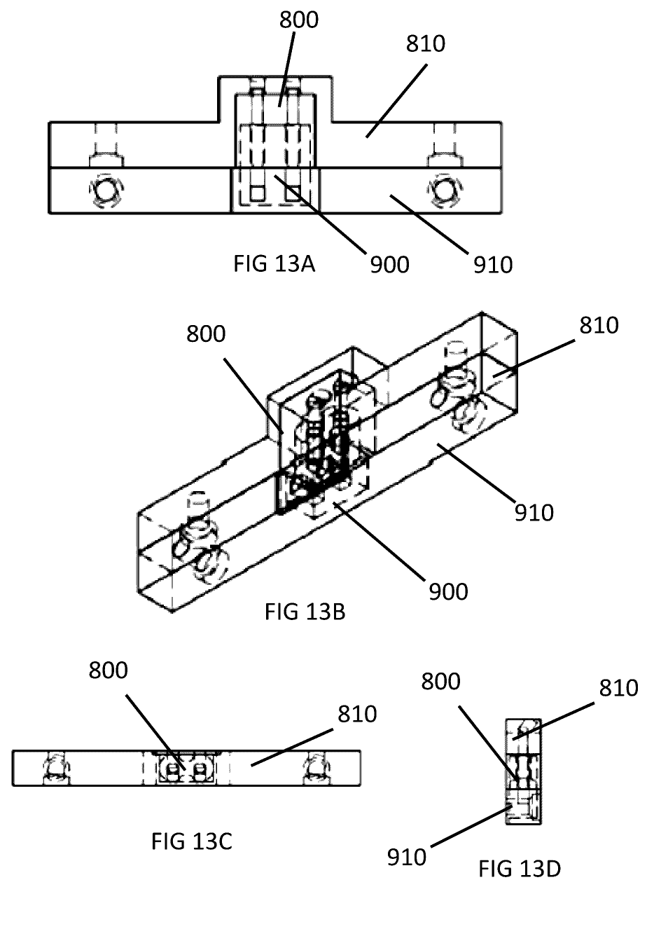

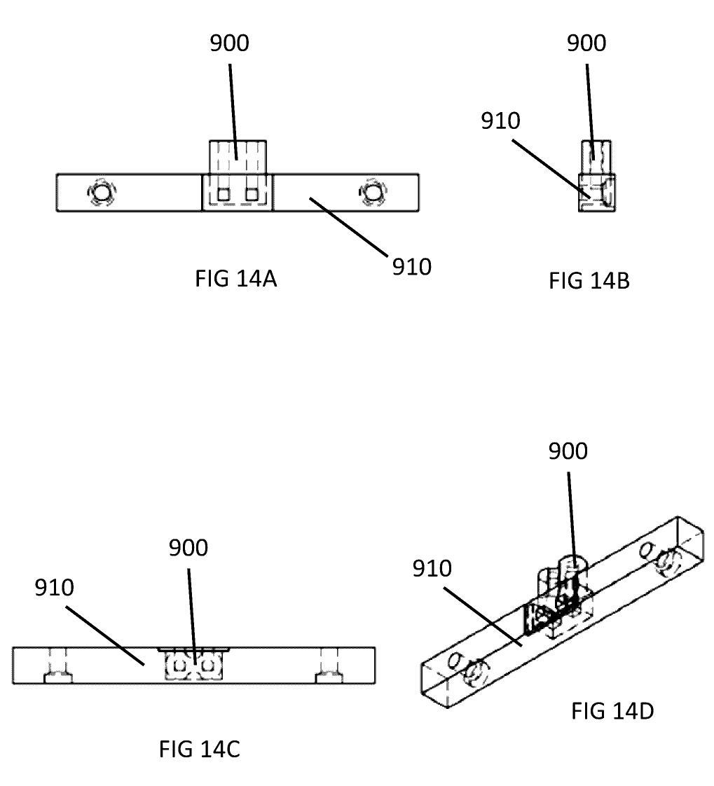

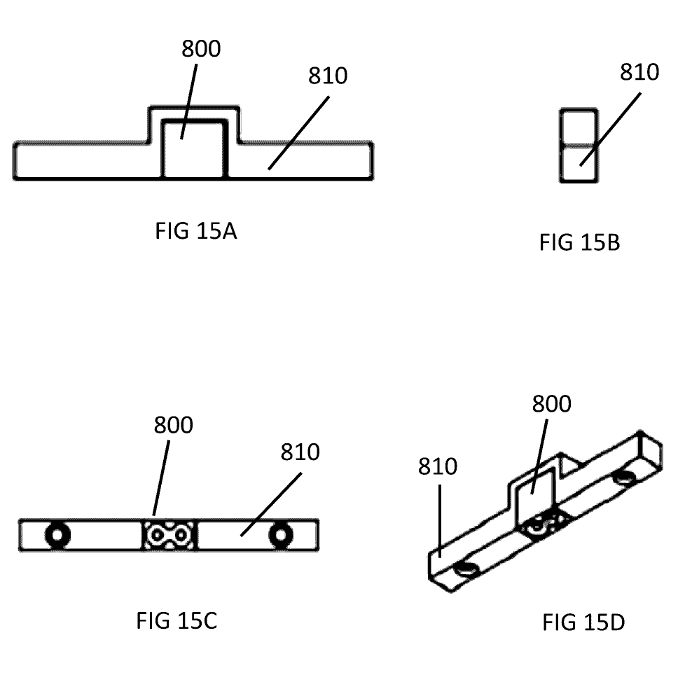

One embodiment of a system described herein will now be described further with reference to certain figures. FIGS. 12A and 12B illustrate one embodiment of components usable in a system described herein. FIGS. 12A and 12B illustrate a first power connector (800), a first connector housing (810), a second power connector (900), and a second connector housing (910). In the embodiment of FIGS. 12A and 12B, the first power connector (800) and second power connector (900) are electrically connected. FIGS. 13A-13D show varying semi-transparent perspective views of the components of FIGS. 12A and 12B. FIGS. 14A-14D illustrate the second power connector (900) and the second connector housing (910). FIGS. 15A-15D illustrate the first power connector (800) and the first connector housing (810).

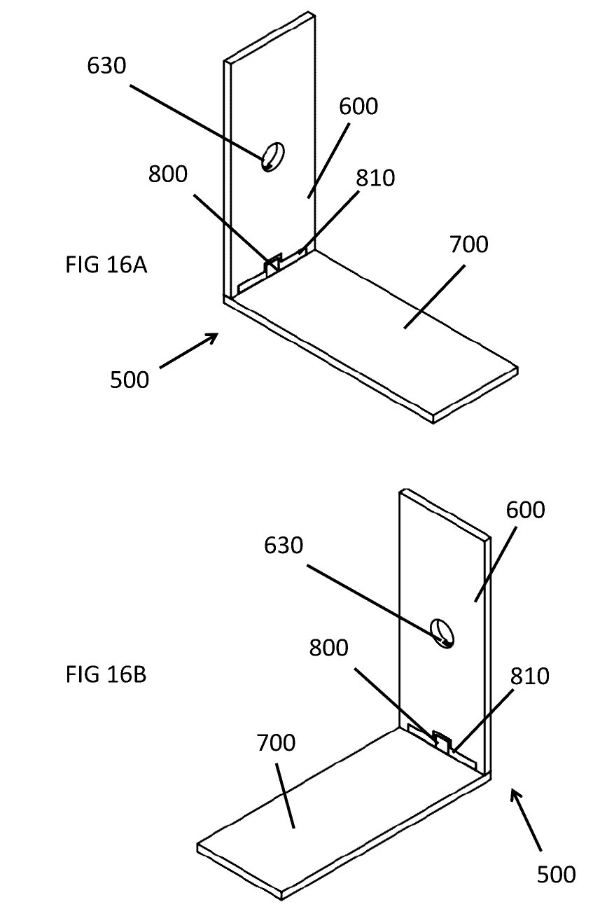

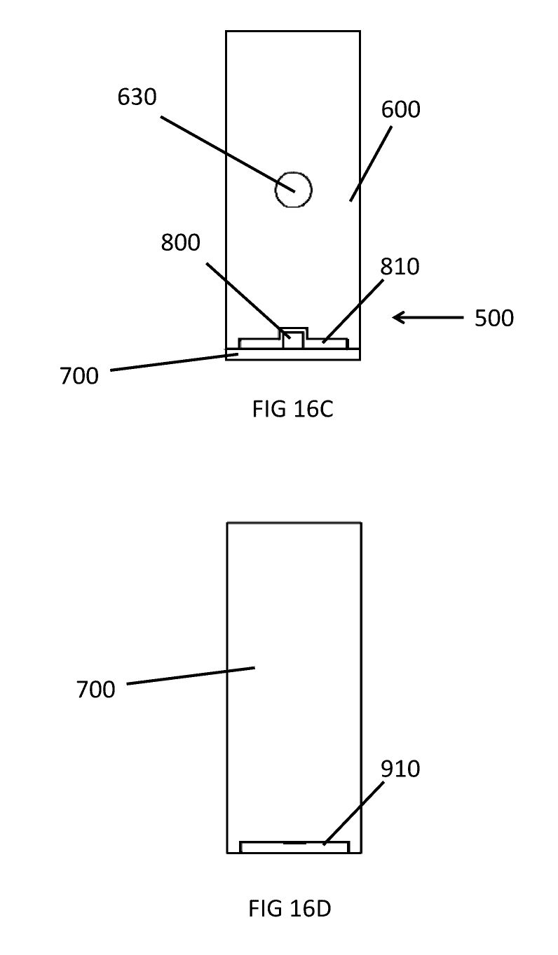

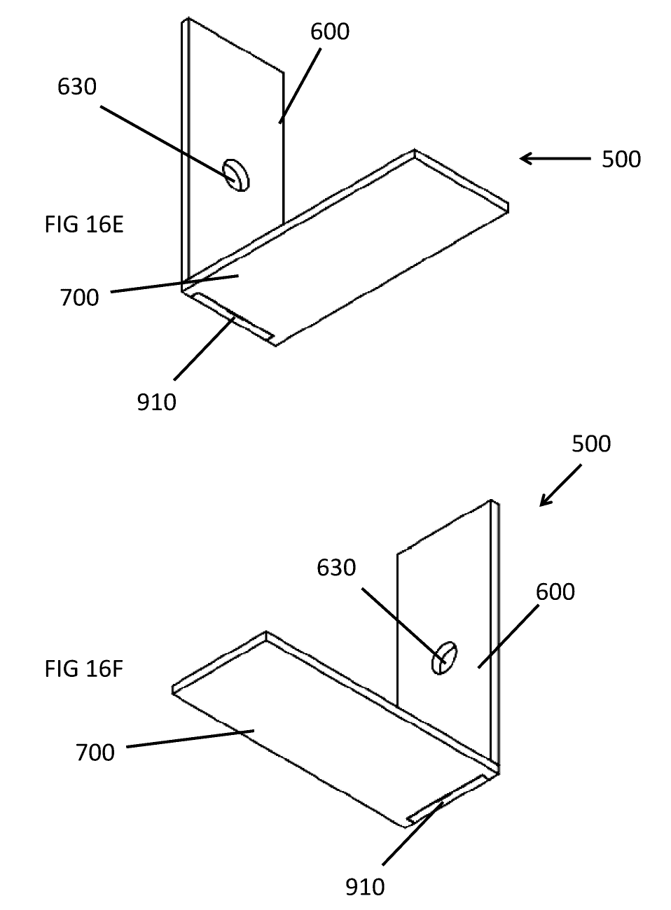

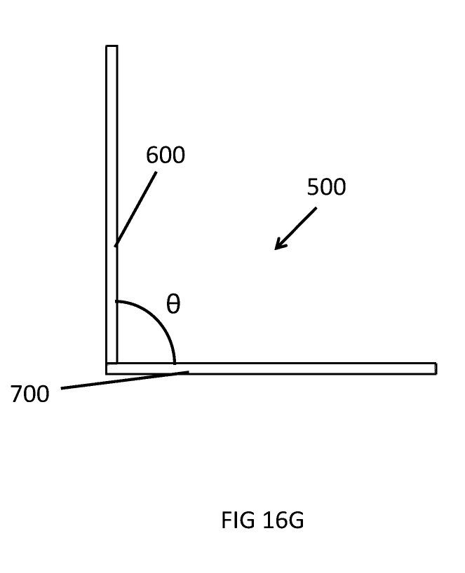

FIGS. 16A-16G illustrate one embodiment of a system described herein comprising the components of FIGS. 12A-15D and certain additional components. In FIGS. 16A-16G, the system (500) comprises a first panel (600), a second panel (700), a first power connector (800) attached to the first panel (600) by a first connector housing (810), the first power connector (800) being flush with at least one surface of the first panel (600), and a second power connector (900) attached to the second panel (700) by a second connector housing (910), the second power connector (900) being flush with at least one surface of the second panel (700). The second power connector (900) is electrically connected to the first power connector (800). The first panel (600) and the second panel (700) abut and form a joint, the joint defining an angle θ between 75° and 105°. In the embodiment of FIGS. 16A-16G, the first panel (600) defines a hole (630) adapted to receive an electrical outlet (shown in FIGS. 18A-18E).

FIGS. 18A-18E illustrate one embodiment of a first panel (600) having an electrical outlet (100). In the embodiment of FIGS. 18A-18E, the electrical outlet (1000) is a Naui Port. In FIGS. 18A-18E, the first panel (600) defines a hole, and an electrical outlet (1000) is disposed within the hole. The first panel (600) further comprises smaller holes adapted to engage outlet fastening pins (1020). The outlet fastening pins (1020) pass through the smaller holes to secure the electrical outlet (1000) to the first panel (600). The first panel defines a channel (620) on a back side (640) not present on the front side (650) which may be adapted or configured to receive a first wire (610). Additionally, an external conduit (630) is disposed on the back side (650) which can have a first wire (610) disposed therein. In this manner, a first panel (600) can be electrically wired in a manner usable with systems and methods described herein.

### VI. Methods of Making an Electrically Wired Assembly

In a further aspect, methods of making an electrically wired assembly are described herein. In some embodiments, a method described herein comprises providing a first panel and a second panel. The method further comprises attaching a first power connector to the first panel flush with at least one surface of the first panel and attaching a second power connector to the second panel flush with at least one surface of the second panel. The method can further comprise abutting the first panel to the second panel to define an angle θ greater than 0° and less than 180°. The method further comprises electrically connecting the first power connector to the second power connector.

Turning now to specific steps and components usable in such steps, methods described herein comprise providing a first panel and a second panel. First and/or second panels can have any components or can be arranged in any configuration not inconsistent with the objectives of the present invention. For example, in some embodiments, a first panel and/or a second panel consistent with first and second panels described herein above in Section V can be used. For example, a first panel can be adapted to be mounted to a wall or a fixture by a back surface of the first panel. Similarly, the second panel can comprise a top surface and a bottom surface, at least one of the top surface and the bottom surface being adapted or configured to be abutted to or mounted to the first panel. Additionally, in some embodiments, a first panel can define a first channel, and a first wire may be disposed in the first channel, the first wire being operable to electrically connect to the first power connector. Similarly, in some embodiments, the second panel defines a second channel, the second channel being operable to receive or engage a second wire in the channel. The second wire is operable to electrically connect to the second power connector. Additionally, in some embodiments, at least one of the first panel and/or the second panel comprise at least one electrical outlet and/or a hole operable to receive or engage at least one electrical outlet.

Methods described herein further comprise abutting the first panel to the second panel to define angle θ greater than 0° and less than 180°. The angle θ can have any value not inconsistent with the objectives of the present invention. For example, the angle θ can have a value consistent with the description of the angle herein above in Section V, such as in Table II. Moreover, the first and second channels can be disposed relative to one another at the angle θ. In some cases, the first and second wires, if present, are disposed relative to one another at the angle θ.

Methods of making an electrically wired assembly described herein further comprise attaching a first power connector to the first panel flush with at least one surface of the first panel and attaching a second power connector to the second panel flush with at least one surface of the second panel. First power connectors and second power connectors can have any components or configurations not inconsistent with the objectives of the present invention. For example, first power connectors and/or second power connectors can be used consistent with the description provided herein above in Section V. For example, in some embodiments, a first power connector is flush with at least one surface of the first panel. Additionally, in some embodiments, the first power connector is flush with at least two surfaces or at least three surfaces of the first panel. The first power connector can be flush with any one, two or three surfaces of the first panel. For example, in some embodiments, the first power connector is flush with the back surface of the first panel. Such a configuration can permit flush mounting of the back surface of the first panel to a substantially vertical surface or to a fixture without interference by a protruding power connector. In certain embodiments, the second power connector is flush with at least one surface of the second panel or at least two surfaces of the second panel. The second power connector can be flush with any surfaces provided on the second panel, such as at least a top surface, at least a bottom surface or at least an end surface of the second panel. In some embodiments, first power connectors are attached directly to first panels. In certain other embodiments, a first power connector is attached to a first connector housing, and the first connector housing is attached to the first panel. A first connector housing can have any properties or characteristics not inconsistent with the objectives of the present invention. For example, a first connector housing can be flush with at least one surface of the first panel, with at least two surfaces of the first panel, or at least three surfaces of the first panel. Similarly, a second connector can be attached directly to the second panel or, in some embodiments, can be attached to a second connector housing which is then attached to the second panel. The second connector housing can be flush with at least one surface of the second panel, at least two surfaces of the second panel, or at least three surfaces of the second panel.

One embodiment of a method described herein will now be described further with reference to certain figures. FIGS. 17A-17H illustrate one embodiment of a method of making an electrically wired assembly. In FIG. 17A, a first panel (600) and a second panel (700) are provided. Each of the first panel (600) and the second panel (700) define cut-out or notched portions shaped and dimensioned to receive a first power connector (800) and a second power connector (900), respectively, while maintaining a final net shape substantially the same as a panel not defining such a cut-out or notched portion. Also provided in FIG. 17A are a first power connector (800) having conductive elements or pins (820) and an insulator portion (830), a first connector housing (810), a second power connector (900) and a second connector housing (910). FIGS. 17B-17E illustrate various perspective views of such components, illustrating their assembly and positioning. FIG. 17F illustrates attaching a first power connector (800) to the first panel (600) by attaching the first power connector (800) to a first connector housing (810) and attaching a second power connector (900) to the second panel (700) by attaching the second power connector (900) to a second connector housing (910) and attaching the second connector housing (910) to the second panel (700). FIG. 17G illustrates alignment to abut the first panel (600) to the second panel (700) to define an angle (not shown) greater than 0° and less than 180°. FIG. 17H illustrates the final assembly of the first panel (600), first power connector (800), first connector housing (810), second panel (700), second connector (not shown) and second connector housing (910). Also illustrated in FIG. 17H is a first channel (620) containing a conduit (630) having a first wire (610) disposed therein.

Various implementations of apparatus and methods have been described in fulfillment of the various objectives of the present disclosure. It should be recognized that these implementations are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

That which is claimed is:

1. A spring cleat comprising:
a housing having a first surface and a second surface;
a lever arm pivotally connected to the housing and spring biased toward the first surface of the housing in an extended position; and
a hook attached to the lever arm,
wherein the lever arm, upon application of a force opposite the first surface upon at least one of the lever arm and the hook, is operable to pivot away from the first surface of the housing towards a depressed position of the lever arm.

2. The spring cleat of claim 1, wherein the housing further comprises a third surface, a fourth surface, and a fifth surface which define a cavity along with the first and second surfaces.

3. The spring cleat of claim 2, wherein the cavity is dimensioned to receive all or substantially all of the lever arm and the hook when the lever arm is in the depressed position.

4. The spring cleat of claim 1, wherein the lever arm is pivotally connected to the housing by a pivot pin engaging the housing and the lever arm.

5. The spring cleat of claim 1, wherein the lever arm is spring biased toward the first surface by a spring wire engaging the lever arm and the second surface of the housing.

6. The spring cleat of claim 1, wherein the hook and the lever arm are integrally formed.

7. The spring cleat of claim 1, wherein the housing is adapted to be fastened external to a substantially vertical surface or to a fixture.

8. The spring cleat of claim 1, wherein the housing is adapted to be recessed within a cavity defined by a substantially vertical surface or a fixture.

9. A system for hanging a fixture from a substantially vertical surface, the system comprising:
a spring cleat comprising:
a housing having a first surface and a second surface;
a lever arm pivotally connected to the housing and spring biased toward the first surface of the housing in an extended position; and
a hook attached to the lever arm,
wherein the lever arm, upon application of a force opposite the first surface upon at least one of the lever arm and the hook, is operable to pivot away from the first surface of the housing towards a depressed position of the lever arm.

10. The system of claim 9, wherein the lever arm is spring biased toward the first surface by a spring wire engaging the lever arm and the second surface of the housing.

11. A method of hanging a fixture from a substantially vertical surface, the method comprising:
providing a spring cleat comprising:
a housing having a first surface and a second surface;
a lever arm pivotally connected to the housing and spring biased toward the first surface of the housing in an extended position; and
a hook attached to the lever arm, wherein the lever arm, upon application of a force opposite the first surface upon at least one of the lever arm and the hook, is operable to pivot away from the first surface of the housing towards a depressed position of the lever arm;
providing a French cleat operable to engage the hook of the spring cleat, the French cleat having a substantially vertical portion and a hook-engaging portion oblique to the substantially vertical portion, the hook-engaging portion having a first side and a second side, the first side of the French cleat being adapted to face the substantially vertical surface when the French cleat is fastened to the substantially vertical surface and to face the fixture when the French cleat is fastened to the fixture and the second side faces in an opposite direction of the first side;
positioning the hook of the spring cleat proximate to the second side of the French cleat; and
moving the spring cleat and the French cleat relative to one another to:
first cause the second surface of the French cleat to apply force to the lever arm to cause the lever arm to pivot towards the depressed position; then
cause the lever arm to pivot towards the extended position; and then
engage the first surface of the French cleat with the hook of the spring cleat.

12. The method of claim 11, wherein providing the French cleat comprises fastening the French cleat to the substantially vertical surface.

13. The method of claim 12, wherein providing the spring cleat comprises fastening the housing of the spring cleat to the fixture.

14. The method of claim 13, wherein the spring cleat is fastened to an external surface of the fixture.

15. The method of claim 13, wherein the housing of the spring cleat is disposed within a recess defined by the fixture.

16. The method of claim 12, wherein the French cleat is fastened to the substantially vertical surface by the substantially vertical portion.

17. The method of claim 11, wherein providing the French cleat comprises fastening the French cleat to the fixture.

18. The method of claim 17, wherein providing the spring cleat fastening the spring cleat to the substantially vertical surface.

19. The method of claim 18, wherein the spring cleat is externally fastened to the substantially vertical surface.

20. The method of claim 18, wherein the housing of the spring cleat is disposed within a recess defined by the substantially vertical surface.
